(19) United States
(12) Patent Application Publication
(10) Pub. No.: US 2015/0232076 A1
(43) Pub. Date: Aug. 20, 2015

(54) Brake Control Device

(71) Applicant: Hitachi Automotive Systems, Ltd., Hitachinaka-shi, Ibaraki (JP)

(72) Inventor: Toshiya Oosawa, Yokohama-shi (JP)

(21) Appl. No.: 14/422,460

(22) PCT Filed: Jun. 21, 2013
(86) PCT No.: PCT/JP2013/067063

§ 371 Date: Feb. 19, 2015

(30) Foreign Application Priority Data
Aug. 23, 2012 (JP) 2012-183708

(51) Int. Cl. B60T 13/14; B60T 8/176; B60T 13/68

(52) U.S. Cl. CPC B60T 13/147; B60T 13/686; B60T 8/176

(57) ABSTRACT

The present invention is provided with: a brake-operation-quantity detection unit (70) for detecting the pedal stroke (Sp) of a brake pedal (2) by a driver; a pump (30) for taking in brake fluid within a master cylinder (4) and boosting the pressure of the wheel cylinder fluid pressure (Pw) on the basis of the increase in the pedal stroke (Sp) of a brake operation member as detected by the brake-operation-quantity detection unit (70); a first intake pathway (15) that connects the master cylinder (4) to the intake side of the pump (30); an internal reservoir (25) provided to the first intake pathway (15); a second intake pathway (13) that is provided in parallel to the first intake pathway (15) and that connects the master cylinder (4) to the internal reservoir (25); and a gate-in valve (23) provided to the second intake pathway (13). When a predetermined sudden braking state has been detected by the brake-operation-quantity detection unit (70), the gate-in valve (23) is opened, and brake fluid is caused to flow in to the internal reservoir (25).

### TECHNICAL FIELD

This invention relates to a brake control device mounted on a vehicle.

### BACKGROUND ART

Conventionally, there is known a brake control device arranged to suck a brake fluid within a master cylinder by a pump at an operation of a brake operation member by a driver, to discharge it to a wheel cylinder's side, and thereby to increase a hydraulic pressure of the wheel cylinder (for example, a patent document 1).

### PRIOR ART DOCUMENT

### Patent Document

Patent Document 1: Japanese Patent Application

### SUMMARY OF THE INVENTION

### Problems which The Invention Is Intended to Solve

However, in the conventional device, when the driver suddenly operates the brake operation member, the operation feeling of the brake operation member is deteriorated, so that an unnatural feeling may be provided to the driver. It is an object of the present invention to provide a brake control device devised to suppress the unnatural feeling of the driver.

### Means for Solving The Problem

For attaining the above-described object, the brake control device of the present invention preferably includes a reservoir disposed in a first suction passage connecting a master cylinder and a suction side of a pump, and a second suction passage connecting the master cylinder and the reservoir independently of the first suction passage. When a predetermined sudden braking states is sensed, the brake fluid flows through the second suction passage to the reservoir.

### Benefit of The Invention

Accordingly, it is possible to suppress to provide the unnatural feeling to the driver.

### BRIEF DESCRIPTION OF DRAWINGS

FIG. 1 is a schematic configuration view showing a brake control apparatus 1 according to a first embodiment, and a hydraulic pressure circuit configuration of a hydraulic pressure unit 6.

FIG. 2 is a view showing a characteristic showing a wheel cylinder hydraulic pressure Pw with respect to a master cylinder hydraulic pressure Pm, in the first embodiment.

FIG. 3 is a view showing a characteristic of the wheel cylinder hydraulic pressure Pw with respect to a pedal stroke Sp, in the first embodiment.

FIG. 4 is a flowchart showing a brake hydraulic pressure control operation according to the first embodiment.

FIG. 5 is a flowchart showing the brake hydraulic pressure control operation according to the first embodiment.

FIG. 6 is a view which is similar to FIG. 1, and which shows a flow of a brake fluid at a brake hydraulic pressure control according to the first embodiment.

FIG. 7 shows a relational characteristic between the pedal stroke Sp and a pedal depression force Fp in the first embodiment.

FIG. 8 shows a relational characteristic between the pedal stroke Sp and the pedal depression force Fp in a sudden depression state in a comparative example.

FIG. 9 is a time chart showing a control according to the first embodiment, when a brake pedal 2 is slowly depressed, or when the brake pedal 2 is depressed at a normal speed.

FIG. 10 is a time chart showing the control according to the first embodiment, when the brake pedal 2 is suddenly depressed (the pedal stroke Sp is smaller than a predetermined value Spa).

FIG. 11 is a time chart showing the control according to the first embodiment, when the brake pedal 2 is suddenly depressed (the pedal stroke Sp is equal to or greater than the predetermined value Spa).

FIG. 12 shows a relational characteristic between a current value and a valve opening pressure of a gate in valve 23, in a second embodiment.

FIG. 13 shows a relation characteristic between a target value of a master cylinder hydraulic pressure Pm and a pedal stroke Sp in a sudden depression state in the second embodiment.

FIG. 14 is a time chart showing the control according to the second embodiment, when a brake pedal 2 is suddenly depressed (the pedal stroke Sp is smaller than a predetermined value Spa).

FIG. 15 is a schematic configuration view showing a brake control device according to a third embodiment, and a hydraulic pressure circuit configuration of a hydraulic pressure unit 6.

### DESCRIPTION OF EMBODIMENTS

Hereinafter, embodiments to attain a brake control device according to the present invention are illustrated with reference to the drawings.

### First Embodiment

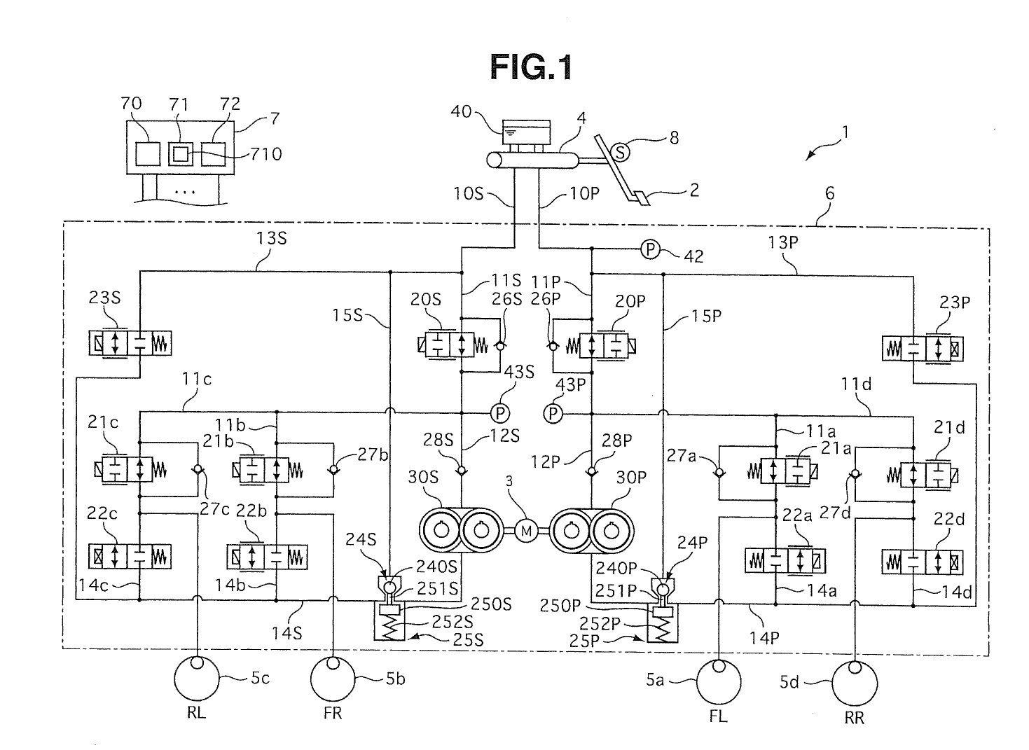

FIG. 1 is a schematic configuration view showing a brake control device 1 according to a first embodiment, and a hydraulic pressure circuit configuration of a hydraulic pressure unit 6. A braking system of a vehicle includes a brake pedal 2, a master cylinder 4, a brake control device 1, and wheel cylinders 5. The vehicle is a vehicle such as a hybrid vehicle and an electric vehicle, which is arranged to generate a regenerative braking force by a motor. However, the vehicle is not limited to these. The brake pedal 2 is a brake operation member to which a brake operation by a driver is inputted. The brake pedal 2 transmits a depression force of the brake pedal 2 as the brake operation force (hereinafter, referred to as a pedal depression force Fp) to the master cylinder 4. The brake pedal 2 is provided with a pedal stroke sensor 8 which is a brake operation amount sensing means arranged to sense an operation amount of the brake pedal 2 (in particular, a pedal stroke Sp) as a brake operation state.

The master cylinder 4 is a hydraulic pressure generating device arranged to generate a brake hydraulic pressure in accordance with the brake operation state. The master cylinder 4 is integrally provided with a reservoir tank 40 which is a fluid source that stores a brake fluid as an operation fluid. The master cylinder 4 is arranged to receive a supply of the brake fluid from the reservoir tank 40. The master cylinder 4 is a tandem type. The master cylinder 4 is connected with the brake control device 1 (the hydraulic pressure unit 6) through brake piping systems (a brake circuit) 10P and 10S of two independent systems (a primary P system and a secondary S system). Hereinafter, members provided to respective systems are distinguished by affixing symbols of P and S if needed. The master cylinder 4 (Respective hydraulic pressure chambers of the master cylinder 4) generates a brake hydraulic pressure (a master cylinder hydraulic pressure Pm) corresponding to the operation force (pedal depression force Fp) by the brake pedal 2. This hydraulic pressure is supplied to the hydraulic pressure unit 6 in the respective systems.

The wheel cylinders 5 are provided to respective wheels FL, FR, RL, and RR of the vehicle. The wheel cylinders 5 are connected with the brake control device 1 (the hydraulic pressure unit 6). The wheel cylinders 5 are arranged to receive the brake fluid from the brake control device 1 (the hydraulic pressure unit 6), and thereby to generate the brake hydraulic pressures (the wheel cylinder hydraulic pressures Pw) of the respective wheels FL, FR, RL, and RR. Hereinafter, a plurality of members provided to correspond to the four wheels are distinguished by affixing symbols a, b, c, and d if needed. The symbol a corresponds to a front left wheel FL. The symbol b corresponds to a front right wheel FR. The symbol c corresponds to a rear left wheel RL. The symbol d corresponds to a rear right wheel RR.

The brake control device (hereinafter, referred to as the device 1) is arranged to perform a boost control to increase the wheel cylinder hydraulic pressure Pw by increasing the master cylinder hydraulic pressure Pm in accordance with the brake operation of the driver. The brake control device is arranged to control the wheel cylinder hydraulic pressure Pw of an arbitrary wheel independently of the brake operation, and thereby to perform an automatic brake control such as an antilock brake control, a motion control of the vehicle (behavior control such as an antiskid control), and a preceding vehicle following control, and a regenerative cooperative control. The device 1 includes the hydraulic pressure unit 6 provided to control the wheel cylinder hydraulic pressure Pw, and a control unit 7 which is an electric control unit configured to control the hydraulic pressure unit 6. The device 1 is a mechatronical integration (an integral device including a mechanical device and an electronic device) which is obtained by integrating these. The both units 6 and 7 may be different members.

The brake circuit 10 is an X-piping system. The brake circuit 10P of the P system extending from the master cylinder 4 is connected, respectively, with the wheel cylinders 5a and 5d of the front left wheel FL and the rear right wheel RR. The brake circuit 10S of the S system is connected, respectively, with the wheel cylinders 5b and 5c of the front right wheel FR and the rear left wheel RL. The brake circuit 10 has an X (diagonal) type piping configuration. Besides, the brake circuit 10 may be an H symbol type piping system in which the piping system are divided into front and rear piping systems, that is, two systems of the front wheels FL and FR and the rear wheels RL and RR.

The hydraulic pressure unit 6 is an actuator disposed between the master cylinder 4 and the wheel cylinders 5. The hydraulic pressure unit 6 is arranged to independently supply the master cylinder hydraulic pressure Pm or the control hydraulic pressure to the respective wheel cylinders 5. The hydraulic pressure unit 6 includes a plurality of control valves 20, and pumps (for example, rotary type pump) 30 which are hydraulic pressure generating sources, as hydraulic pressure devices (actuators) arranged to generate the control hydraulic pressure supplied to the wheel cylinders 5, and so on. Moreover, the hydraulic pressure unit 6 includes a housing receiving these hydraulic pressure devices. When the brake pedal 2 is depressed, the master cylinder 4 supplies the brake hydraulic pressure through the brake piping systems 10P and 10S to the hydraulic pressure unit 6, and the wheel cylinders 5 generate the wheel cylinder hydraulic pressure Pw by the brake fluid supplied from the hydraulic pressure unit 6. The hydraulic pressure unit 6 is arranged to control the wheel cylinder hydraulic pressure Pw to be equal to or smaller than the master cylinder hydraulic pressure Pm, to control the wheel cylinder hydraulic pressure Pw to be equal to or greater than the master cylinder hydraulic pressure Pm, and also to hold the wheel cylinder hydraulic pressure Pw to a substantially constant value.

Hereinafter, the brake circuit 10 which is the hydraulic pressure circuit is illustrated as taking the P system as an example. The brake circuit 10 includes a plurality of passages 11 which are disposed in the hydraulic pressure unit 6, and in which the brake fluid flows, and so on. The brake circuit 10 includes a supply passage 11 extending (directing) from a master cylinder 4's side to a wheel cylinder 5's side. The supply passage 11 is provided with a gate out valve 20 which is a cutout (shut-off) valve arranged to switch a connection and a disconnection of the supply passage 11. Moreover, there is provided a check valve 26 provided in parallel with the gate out valve 20, and arranged to allow the only flow of the brake fluid from the master cylinder 4's side to the wheel cylinder 5's side (the discharge side of the pump 30). The supply passage 11 on the wheel cylinder 5's side of the gate out valve 20 is bifurcated to a pressure increase passage 11a on the front wheel FL's side and a pressure increase passage 11d on the rear wheel RR's side. The supply passage 11 on the wheel cylinder 5's side of the gate-out valve 20 is bifurcated to a pressure increase passage 11a on the front wheel FL's side and a pressure increase passage 11d on the rear wheel RR's side. The pressure increase passage 11a is connected to the wheel cylinder 5a of the front left wheel FL. The pressure increase passage 11d is connected to the wheel cylinder 5d of the rear right wheel RR. The pressure increase passages 11a and 11d are provided, respectively, with pressure increase valves (IN valves) 21a and 21d arranged to switch the connections and the disconnections of the pressure increase passages 11a and 11d. Moreover, there is provided a check valve 27 disposed in parallel with the pressure increase valve 21, and arranged to allow only a flow of the brake fluid from the wheel cylinder 5's side to the master cylinder 4's side (the discharge side of the pump 30). In this way, the wheel cylinders 5a and 5d are connected to the master cylinder 4 through the pressure increase passages 11a and 11d and the supply passage 11.

The pressure decrease passages 14a and 14d are connected, respectively, to the pressure increase passages 11a and 11d on the wheel cylinder 5's side of the pressure increase valve 21. The pressure decrease passage 14a is a pressure decrease passage which is on the front wheel FL's side, and which is connected with the wheel cylinder 5a. The pressure decrease passage 14d is a pressure decrease passage which is on the rear wheel RR's side, and which is connected with the wheel cylinder 5d. The pressure decrease passages 14a and 14d are provided, respectively, with pressure decrease valves (OUT valves) 22a and 22d arranged to switch connections and disconnections of the pressure decrease passages 14a and 14d. The pressure decrease passages 14a and 14d are interflowed into the pressure decrease passage 14. The pressure decrease passage 14 is connected to an internal reservoir 25 provided between the suction side of the pump 30 and the master cylinder 4.

On the other hand, the supply passage 11 is bifurcated on the master cylinder 4's side of the gate out valve 20, so as to form a first suction passage 15 and a second suction passage 13. The suction side of the pump 30 is connected with the master cylinder 4 (the reservoir tank 40) through the first suction passage 15 and the supply passage 11. That is, the first suction passage 15 is a passage connecting the master cylinder 4 and the suction side of the pump 30. The internal reservoir 25 is provided on the first suction passage 15. The first suction passage 15 is connected through the internal reservoir 25 to the suction side of the pump 30. The second suction passage 13 is a passage which is provided in parallel with the first suction passage 15, and which connects the master cylinder 4 and the internal reservoir 25. One end of the second suction passage 13 is connected to the first suction passage 15. The other end of the second suction passage 13 is connected to the pressure decrease passage 14d. The second suction passage 13 is provided with a gate in valve 23 which is a cutoff (shut-off) valve arranged to switch the connection and the disconnection of the second suction passage 13. Besides, the second suction passage 13 is not specifically limited as long as the second suction passage 13 is a passage connecting the master cylinder 4 and the internal reservoir 25. For example, the one end of the second suction passage 13 may be connected with the supply passage 11 between the master cylinder 4 and the gate out valve 20, and the other end may be connected with the first suction passage 15 between the suction side of the pump 30 and the internal reservoir 25, or may be directly connected with the internal reservoir 25.

The discharge side of the pump 30 is connected through the discharge passage 12 to the supply passage 11 on the wheel cylinder 5's side of the gate out valve 20. A check valve 28 is provided on the discharge side (the discharge passage 12) of the pump 30. The check valve 28 is arranged to suppress a reverse flow of the brake fluid from the supply passage 11 between the gate out valve 20 and the pressure increase valve 21, to the discharge side of the pump 30. The discharge side of the pump 30 is connected through the discharge passage 12 and the supply passage 11 (the gate out valve 20) to the master cylinder 4. Moreover, the discharge side of the pump 30 is connected through the discharge passage 12 and the supply passage 11 (the pressure increase passages 11a and 11d) to the wheel cylinders 5a and 5d. That is, the supply passage 11 is bifurcated from the first suction passage 15. This supply passage 11 (the first brake circuit) connects the discharge side (the discharge passage 12) of the pump 30, the master cylinder 4, and the wheel cylinders 5. This supply passage 11 is provided with the gate out valve 20. The discharge side of the pump 30 is provided with a hydraulic pressure sensor 43 which is an internal pressure sensor, and which is located on the discharge passage 12 on the downstream side of the check valve 28. The hydraulic pressure sensor 43 is configured to sense a pressure on the discharge side of the pump 30 (the discharge pressure of the pump 30), and to input the sensed value to the control unit 7.

The brake circuit 10S of the S system is constituted similarly to the brake circuit 10P of the P system. Besides, the brake circuit 10P is provided with a hydraulic pressure sensor 42 which is located on the supply passage 11 on the master cylinder 4's side of the gate out valve 20. The hydraulic pressure sensor 42 is arranged to sense the master cylinder hydraulic pressure Pm, and to input the sensed value to the control unit 7.

The pumps 30 are provided, respectively, to the P and S systems. The pumps 30 are arranged to be drivingly rotated, and to suck and discharge the brake fluid in the respective piping systems. The pumps 30 are a gear pump having an excellent silence characteristic, in particular, an external gear pump. However, the pumps 30 are not limited to those. It is possible to employ an internal gear pump, and a plunger pump. The motor 3 is a direct current brush motor. However, the motor 3 is not limited to this. In the motor 3, a rotation speed is controlled by a command voltage from the control unit 7. With this, the motor 3 drives the pumps 30. The pumps 30 are arranged to serve as hydraulic pressure sources other than the master cylinder 4, to suck the brake fluid within the master cylinder 4 through the internal reservoirs 25, to discharge the brake fluid to the wheel cylinder 5's side, and thereby to increase the wheel cylinder hydraulic pressures Pw. Moreover, the pump 30 is arranged to scrape out the brake fluid stored in the internal reservoir 25, and to return the brake fluid through the gate out valve 20 to the master cylinder 4's side.

The internal reservoir 25 is a reservoir received within the hydraulic pressure unit 6, and arranged to store the brake fluid. The internal reservoir 25 stores the brake fluid transmitted through the pressure decrease valve 22 or the gate in valve 23. The internal reservoir 25 is a reservoir having a pressure regulating function to regulate the pressure of the brake fluid. The internal reservoir 25 includes a piston 250 arranged to stroke by the inflow (influx) of the brake fluid, and a check valve 24 which is a pressure regulating valve that is arranged to regulate the brake fluid amount flowing from the first suction passage 15 to the internal reservoir 25, in cooperation with the piston 250. The check valve 24 is provided on the first suction passage 15 between the master cylinder 4 and the internal reservoir 25. When the pump 30 is not actuated and the brake fluid is not supplied from the master cylinder 4, the piston 250 of the internal reservoir 25 is urged by a spring 252 which is an urging means, and arranged to push a valve element (ball) 240 of the check valve 24 through a rod 251 (for example, against a force of a return spring (not shown) of the check valve) in the upward direction. Accordingly, the valve element 240 is separated from a seat portion (valve seat) by a predetermined amount, so that the check valve 24 becomes a valve opening state. At this time, the first suction passage 15 is connected through the internal reservoir 25 to the suction side of the pump 30. When the brake fluid of the predetermined amount flows into (is stored in) the internal reservoir 25, the check valve 24 is closed so as to disconnect the flow of the brake fluid from the master cylinder 4's side through the first suction passage 15 to the suction side of the pump 30.

When the master cylinder hydraulic pressure Pm is supplied from the first suction passage 15, the check valve 24 is brought from the valve opening state to the valve closing state. The urging force of the spring 252 (a value obtained by subtracting the urging force of the return spring of the check valve) is represented by F. A pressure receiving area of the piston 250 is represented by S1. When the master cylinder hydraulic pressure Pm is acted to the piston 250 in the valve opening state of the check valve 24 and accordingly Pm×S1>F is satisfied, the piston 250 is stroked (moved) in a direction to compress the spring 252. Accordingly, the valve element 240 is also stroked toward the seat portion. When the valve element 240 is stroked by the predetermined amount, and seated on the seat portion, the flow of the brake fluid from the first suction passage 15 to the internal reservoir 25 is blocked. When the brake fluid within the wheel cylinders 5a and 5d flows through the pressure decrease passage 14 into the internal reservoir 25, or when the brake fluid within the master cylinder 4 flows through the second suction passage 13 into the internal reservoir 25, the piston 250 is moved in a direction to compress the spring 252, and a volume of the internal reservoir 25 is increased. With this, the brake fluid is stored. Besides, the piston 250 and the valve element 240 are different members. (An upper limit of) The stroke (movement) amount of the piston 250 is set greater than (an upper limit of) the stroke amount of the valve element 240. Accordingly, even after the valve element 240 is stroked by the predetermined amount and seated on the seat portion, the piston 250 can be stroked so as to increase the storage amount of the brake fluid to the internal reservoir 25.

When the pump 30 is actuated, the brake fluid stored in the internal reservoir 25 is pumped up, and recirculated to the supply passage 11's side. At this time, even when the check valve 24 is closed, the pressure of the internal reservoir 25 is decreased by the pump-up by the pump 30, so as to push and open the check valve 24. That is, the pressure on the master cylinder 4's side of the valve element 240 is the master cylinder hydraulic pressure Pm in the valve closing state of the check valve 24. On the other hand, the pressure on the internal reservoir 25's side of the valve element 240 is Ps=F/S1. Accordingly, the pressure acted to the suction side of the pump 30 does not become equal to or greater than F/S1, and is maintained equal to or smaller than the predetermined pressure. When the pump 30 sucks the brake fluid of the internal reservoir 25 in this state, the pressure Ps is decreased. Consequently, the piston 250 is pushed toward the valve element 240 by the urging force F of the spring 252. At this time, a diameter of a hydraulic path of the check valve 24 (a valve seat diameter), that is, a sectional area of the check valve 24 through which the brake fluid flows is represented as S2. When Pm×S2<F is satisfied, the valve element 240 is separated from the seat portion, and the check valve 24 becomes the valve opening state. The valve opening pressure F/S2 is set to a predetermined pressure. In this valve opening state, the pump 30 sucks the brake fluid from the internal reservoir 25, and is brought to a state where the brake fluid can be sucked from the master cylinder 4 (the first suction passage 15).

Then, when the master cylinder hydraulic pressure Pm is acted to the piston 250 of the internal reservoir 25 and the piston 250 is moved in a direction to compress the spring 252, the valve closing operation is performed as described above. As described above, the check valve 2 automatically repeats the opening and closing operations at the actuation of the pump 30. With this, the pump 30 can suck the brake fluid from the master cylinder 4 (the first suction passage 15), and increase the wheel cylinder hydraulic pressure Pw. Moreover, the pressure acted to the suction side of the pump 30 is regulated to a value equal to or smaller than the predetermined value.

The valves 20 to 23 are electromagnetic valves (solenoid valves). The valves 20 to 23 are known members arranged to generate the electromagnetic force by applying a driving current to solenoids (coils), to reciprocate plunger and so on, and thereby to open and close the valves.

The gate out valve 20 is a proportional control valve arranged to proportionally vary an opening degree of the valve by a current value. The gate out valve 20 is a normally-open valve (normally open type) arranged to open in a deenergized state. The gate out valve 20 is proportionally acted between a full open state and a fully closed state by a command current from the control unit 7. The gate out valve 20 is arranged to connect and disconnect the master cylinder 4, the discharge side of the pump 30, and the pressure increase valves 21, and thereby to proportionally control the flow rate (flow volume) or the hydraulic pressure. Besides, when the master cylinder hydraulic pressure Pm>(the pressure of the discharge side of the pump 30) is satisfied, the check valve 26 is acted to be opened so as to transmit the master cylinder hydraulic pressure Pm to the discharge side of the pump 30 and the pressure increase valve 21's side. A pressure difference (the valve opening pressure) between the pressure on the upstream side of the gate out valve 20 (corresponding to the master cylinder hydraulic pressure Pm) and the pressure on the downstream side of the gate out valve 20 (which is a pressure on the discharge side of the pump 30, and which corresponds to the wheel cylinder hydraulic pressure Pw) is acted to the valve element of the gate out valve 20. By controlling the current applied to the solenoid of the gate out valve 20, it is possible to control the above-described pressure difference to a desired value. That is, the urging force of the spring arranged to urge the valve element of the gate out valve 20 is uniquely determined in accordance with the position of the valve element. Accordingly, by controlling the current value to a predetermined value, the valve element is stroked to regulate the opening degree, that is, the flow rate flowing in the gate out valve 20, until the force by the pressure difference to finally balance the electromagnetic force according to this current value and the urging force of the spring is acted to the valve element. With this, the target pressure difference is attained. Hereinafter, this is referred to as a balance control of the gate out valve 20. The current value applied to the solenoid for controlling the pressure difference to the predetermined value is referred to as a balance current value. For example, when the pressure increase valve 21 is opened and the pressure decrease valve 22 is closed, the pressure increase amount of the wheel cylinder 5 by the pump 30 is determined in accordance with a difference between the discharge fluid amount of the pump 30, and the leak fluid amount from the gate out valve 20 to the master cylinder 4's side. Accordingly, by controlling the rotation speed of the motor 3 (the pump discharge fluid amount), and by energizing the solenoid of the gate out valve 20 to control the electromagnetic force of the solenoid (the balance current value) so that the pressure difference becomes the desired value, it is possible to automatically regulate the opening degree (the above-described leak fluid amount) of the gate out valve 20, and to arbitrarily regulate the wheel cylinder hydraulic pressure Pw.

The gate in valve 23 is a proportional control valve. The gate in valve 23 is a normally-closed valve (normally-closed type) arranged to close a valve in the deenergized state. The gate in valve 23 is actuated between a full open state and a fully closed state by a command current from the control unit 7. With this, the gate in valve 23 is arranged to connect or disconnect the master cylinder 4 and the internal reservoir 25, and thereby to proportionally control the flow rate or the hydraulic pressure.

The pressure increase valve 21 is an ON/OFF valve arranged so that the opening degree of the valve is positioned at two positions of the full open state and the fully closed state. The pressure increase valve 21 is a normally-open valve arranged to open the valve in the deenergized state. The pressure increase valve 21 is arranged to be opened and closed by the command current from the control unit 7. The pressure increase valve 21 is arranged to open the valve to supply the master cylinder hydraulic pressure Pm or the pump discharge pressure which is supplied to the pressure increase valve 21, to the wheel cylinder 5, or to close the valve to shut off this supply to arbitrarily increase or hold the wheel cylinder hydraulic pressure Pw. Moreover, when the wheel cylinder hydraulic pressure Pw>(the pressure on the discharge side of the pump 30) is satisfied, the check valve 27 is opened to release the wheel cylinder hydraulic pressure Pw to the master cylinder 4. The pressure decrease valves 22 on the front wheel FL and FR's side are proportional control valves. The pressure decrease valves 22 on the rear wheel RL and RR's side are ON/OFF valves. The pressure decrease valves 22 on the front wheel FL and FR's side and the pressure decrease valves 22 on the rear wheel RL and RR's side are normally-closed valves arranged to be closed in the deenergized state. The pressure decrease valves 22 are arranged to be opened and closed by the command current from the control unit 7. The pressure decrease valve 22 is arranged to be opened to temporarily supply the brake fluid within the wheel cylinder 5 to the internal reservoir 25 (that is, to discharge the brake fluid from the wheel cylinder 5), and to be closed to shut off this supply (the discharge). With this, the pressure decrease valve 22 is arranged to arbitrarily decrease the wheel cylinder hydraulic pressure Pw. Besides, the pressure increase valve 21 and the pressure decrease valve 22 on the rear wheel RL and RR's side may be proportional control valves.

The control unit 7 is an electric control unit configured to output a control command to the hydraulic pressure unit 6, and thereby to control the brake hydraulic pressures of the wheels FL, FR, RL, and RR. The control unit 7 is configured to receive the sensed values transmitted from the pedal stroke sensor 8 and the hydraulic pressure sensors 42 and 43, and the information relating to the running state transmitted from the vehicle, and to control the openings and the closings of the electromagnetic valves 20 and so on and the rotation speed of the motor 3 (the discharge amount of the pump 30). With this, the control unit 7 attains the boost control, the antilock brake control, the automatic brake control, the regenerative cooperative control and so on.

The antilock brake control relieves the locking tendency by controlling (the pressure decrease and so on) the wheel cylinder hydraulic pressure Pw of the wheel having (being in) the locking tendency. An antilock brake control section 72 provided to the control unit 7 is configured to presume a surface μ, for example, based on the sensed value of the wheel cylinder hydraulic pressure Pw, and to control (decrease, and so on) the wheel cylinder hydraulic pressure Pw based on the predetermined tire model so that the slip rate of the wheel being the locking tendency becomes within a predetermined range to obtain the maximum braking force while suppressing the locking tendency. For example, the pressure decrease control is arranged to decrease the wheel cylinder hydraulic pressure Pw by controlling the pressure decrease valve 22 in the valve opening direction. The pressure decrease control is configured to control so that the wheel cylinder hydraulic pressure Pw becomes the target hydraulic pressure, by controlling the valve opening amount and so on of the pressure decrease valve 22. The brake fluid discharged from the wheel cylinder 5 flows through the pressure decrease passage 14 into the internal reservoir 25. The brake fluid stored in the internal reservoir 25 is scraped out by the pump 30, and returned through the gate out valve 20 (the supply passage 11) to the master cylinder 4's side. Besides, in this embodiment, at least one (the pressure decrease valves 22a and 22b of the front wheels FL and FR) of the pressure decrease valves 22 of the respective systems is the proportional control valve. Accordingly, it is possible to perform more detailed control, and to attain the smooth pressure decrease control.

Moreover, when it is deficient only by the regenerative braking force (and the braking force by the master cylinder hydraulic pressure Pm) with respect to the driver's desired braking force at the braking by the depression of the brake, the regenerative cooperative brake control is arranged to compensate for that deficiency by the hydraulic pressure braking force by the hydraulic pressure unit 6. For example, when the necessary hydraulic pressure braking force is increased, the gate out valve 20 is controlled to an intermediate opening degree by the balance control, the pressure increase valve 21 is controlled in the valve opening direction, and the pressure decrease valve 22 is controlled in the valve closing direction. Then, the pump 30 is driven to suck the brake fluid from the master cylinder 4 and to discharge it. With this, the pump pressure of the deficiency amount is supplied to the wheel cylinders 5. Moreover, when the necessary hydraulic pressure braking force is decreased, the balance control of the gate out valve 20 is performed, the pressure increase valve 21 is opened, the pressure decrease valve 22 is closed, and the pump 30 is stopped. With this, the wheel cylinder hydraulic pressure Pw is discharged through the gate out valve 20 (the supply passage 11) to the master cylinder 4 while the wheel cylinder hydraulic pressure Pw of the deficiency amount is remained.

Hereinafter, the boost control is illustrated in detail. The boost control is configured to add the assist hydraulic pressure generated by driving the hydraulic pressure unit 6 (by using the discharge hydraulic pressure of the pump 30), to the master cylinder hydraulic pressure Pm generated by the master cylinder 4 in accordance with the brake operation. With this, the boost control generates the wheel cylinder hydraulic pressure Pw greater than the master cylinder hydraulic pressure Pm.

The control unit 7 includes a brake operation amount sensing section 70 and a brake hydraulic pressure control section 71. The brake operation amount sensing section 70 senses, as the brake operation amount, the pedal stroke Sp based on the input signal from the pedal stroke sensor 8. Besides, the master cylinder hydraulic pressure Pm may be sensed as the brake operation amount based on the input signal from the hydraulic pressure sensor 42.

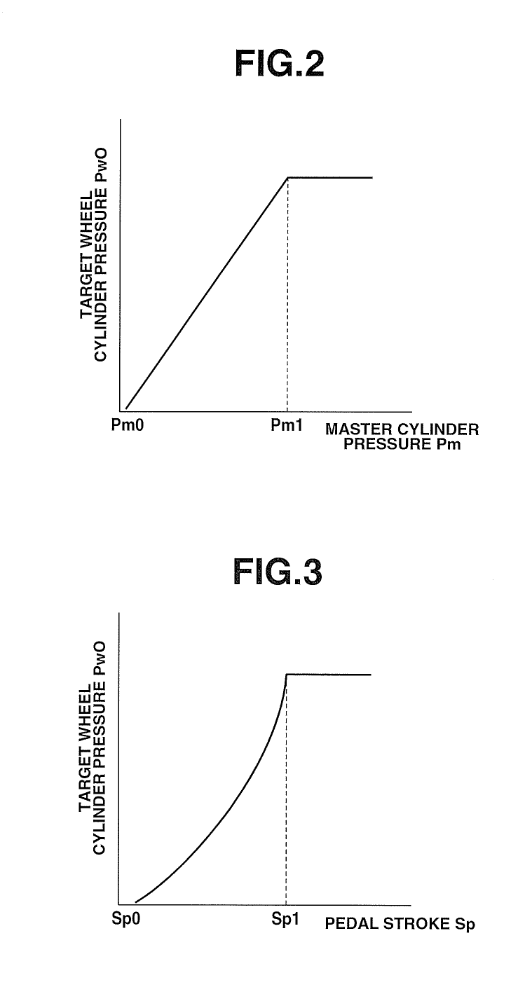

The brake hydraulic pressure control section 71 previously sets a map of the characteristics of the wheel cylinder hydraulic pressure Pw with respect to the parameter (for example, the master cylinder hydraulic pressure Pm) indicative of the driver's desired braking force. The brake hydraulic pressure control section 71 is arranged to calculate the target wheel cylinder hydraulic pressure Pw0 to follow the above-described characteristics (the map) based on the sensed parameter (the master cylinder hydraulic pressure Pm). Then, the brake hydraulic pressure control section 71 controls the actuators of the hydraulic pressure unit 6 so that the sensed wheel cylinder hydraulic pressures Pw corresponds to the target wheel cylinder hydraulic pressure Pw0. FIG. 2 shows the above-described characteristics (map) of the target wheel cylinder hydraulic pressure Pw0 when the master cylinder hydraulic pressure Pm is used as the parameter. This map has the following characteristics. In a range where the master cylinder hydraulic pressure Pm is equal to or smaller than a predetermined minute value Pm0, the target wheel cylinder hydraulic pressure Pw0 is zero. In a range where the master cylinder hydraulic pressure Pm is greater than Pm0 and equal to or smaller than a predetermined value Pm1, the target wheel cylinder hydraulic pressure Pw0 is proportionally (at an increase gradient greater than 1) increased in accordance with the increase of the master cylinder hydraulic pressure Pm. When the master cylinder hydraulic pressure Pm becomes greater than the predetermined value Pm1, the target wheel cylinder hydraulic pressure Pm0 becomes a substantially constant value, irrespective of the magnitude of the master cylinder hydraulic pressure Pm. Besides, the pedal stroke Sp may be used as the parameter. In this case, the above-described characteristics (the map) of the target wheel cylinder hydraulic pressure Pw0 becomes the following characteristics, for example, as shown in FIG. 3. In a range where the pedal stroke Sp is equal to or smaller than a minute predetermined value Sp0, the target wheel cylinder hydraulic pressure Pw0 is zero. In a range where the pedal stroke Sp is greater than Sp0, and equal to or smaller than the predetermined value Sp1, the target wheel cylinder hydraulic pressure Pw0 is increased in accordance with the increase of the pedal stroke Sp, and moreover the increase gradient thereof is gradually increased. When the pedal stroke Sp becomes greater than the predetermined value Sp1, the target wheel cylinder hydraulic pressure Pw0 becomes substantially constant value irrespective of the magnitude of the pedal stroke Sp.

The brake hydraulic pressure control section 71 includes a suction passage selecting section 710. The suction passage selecting section 710 is configured to judge whether or not the vehicle is in a predetermined sudden braking state based on the pedal stroke Sp sensed by the brake operation amount sensing section 70. In particular, the brake hydraulic pressure control section 71 is configured to judge whether or not the vehicle is in a sudden depression state where the brake pedal 2 is suddenly depressed. When the variation rate of the sensed pedal stroke Sp to the time is a spike stop corresponding value indicative of the predetermined sudden operation and the operation direction of the brake pedal 2 is in the depression direction (the sensed pedal stroke Sp is increased), the sudden depression state (in a broad sense) is judged. Besides, the sudden depression state may be sensed by using the sensed master cylinder hydraulic pressure Pm (the variation rate of the sensed master cylinder hydraulic pressure Pm to the time, and the increase and decrease directions of the sensed master cylinder hydraulic pressure Pm). Moreover, the suction passage selecting section 710 is configured to judge whether or not the brake operation amount is equal to or greater than the predetermined amount based on the pedal stroke Sp sensed by the brake operation amount sensing section 70. When the sensed pedal stroke Sp is equal to or greater than the predetermined amount Spa, it is judged that the brake operation amount is equal to or greater than the predetermined amount. The predetermined value Spa is set to the pedal stroke Sp corresponding to the point at which the characteristics of the hydraulic pressure of the wheel cylinder 5—the fluid amount consumption is started to become substantially linear. Besides, it may be judged whether or not the brake operation amount is equal to or greater than the predetermined amount, by using the master cylinder hydraulic pressure Pm.

The suction passage selecting section 710 is a selecting means configured to select the suction passage for flowing the brake fluid of the master cylinder 4 into the internal reservoir 25 from the first suction passage 15 and the second suction passage 13, in accordance with the brake operation state (whether or not the vehicle is in the sudden braking state, or whether or not the brake operation amount is equal to or greater than the predetermined amount). With this, when the predetermined sudden braking state is not sensed, the brake fluid flows into the internal reservoir 25 through the first suction passage 15, not through the second suction passage 13. When the predetermined sudden braking state is sensed, basically, the gate in valve 23 is opened to connect the second suction passage 13. In this case, as described later, the check valve 24 is closed due to the response delay of the pump 30 (the motor 3). Accordingly, the first suction passage 15 is closed. With this, the brake fluid flows from the master cylinder 4 into the internal reservoir 25 through the second suction passage 13, not through the first suction passage 15. Even when the predetermined sudden braking state is sensed, when the brake operation amount which is equal to or greater than the predetermined amount (the pedal stroke Sp which is equal to or greater than the predetermined value Spa) is sensed, or when the master cylinder hydraulic pressure Pm which is equal to or greater than the predetermined value Pma is sensed, the gate in valve 23 is closed. With this, the brake fluid flows into the internal reservoir 25 through the first suction passage 15, not through the second suction passage 13. The above-described predetermined value Pma is set equal to or smaller than a pressure resistance value of the pump suction side.

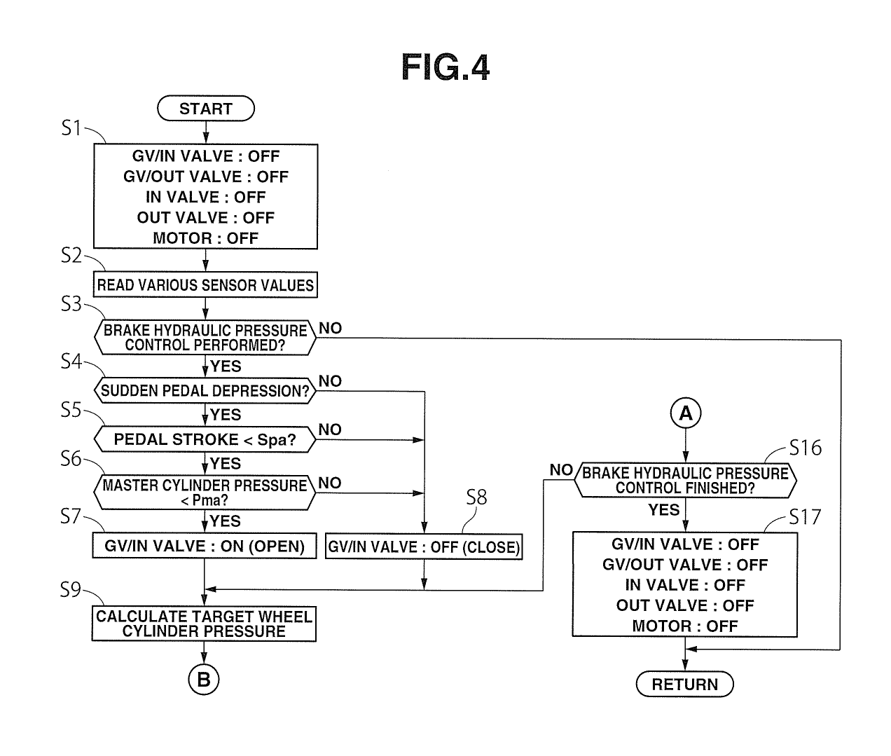

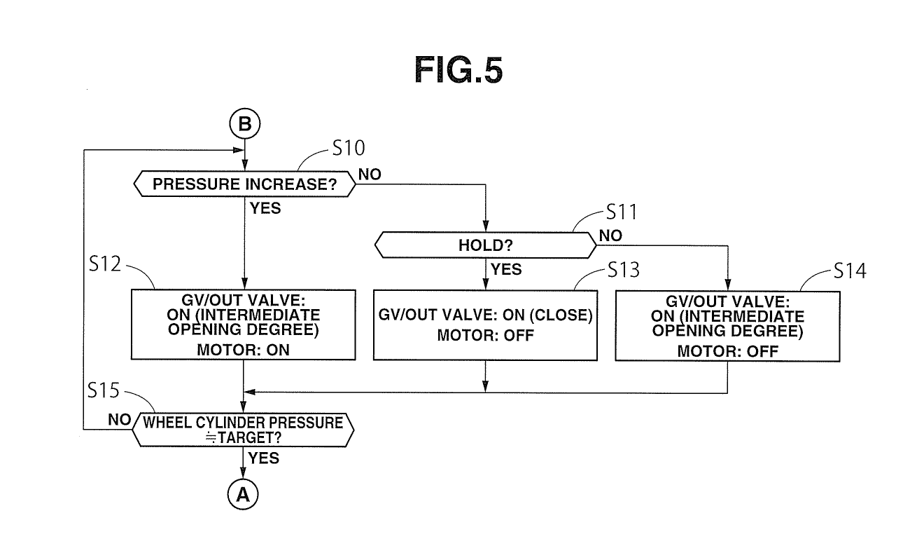

FIG. 4 and FIG. 5 are flowcharts representing a control operation by the brake hydraulic pressure control section 71 according to this embodiment. This control flow is repeated at a predetermined cycle.

At step S1, the actuators of the hydraulic pressure unit 6 are brought to the non-actuation state. That is, the gate in valve 23 is not actuated (is closed), the gate out valve 20 is not actuated (is opened), the pressure increase valve 21 is not actuated (is opened), the pressure decrease valve 22 is not actuated (is closed), and the motor 3 (the pump 30) is not actuated. Then, the process proceeds to step S2.

At step S2, the sensed values of the various sensors are read. Then, the process proceeds to step S3.

At step S3, it is judged whether or not the brake hydraulic pressure control (the boost control) is performed. When it is judged that the control is performed, the process proceeds to step S4. When it is judged that the control is not performed, this control cycle is finished.

At step S4 to S8, the suction passage selecting section 710 selects the suction passage. At step S4, it is judged whether or not the vehicle is in the predetermined braking state, in particular, whether or not the vehicle is in the sudden depression state. When it is judged that the vehicle is in the sudden brake state, the process proceeds to step S5. When it is not judged that the vehicle is in the sudden depression state, the process proceeds to step S8.

At step S5, it is judged whether or not the brake operation amount is equal to or greater than the predetermined amount, in particular, whether or not the sensed pedal stroke Sp is equal to or greater than the predetermined value Spa. When it is judged that the sensed pedal stroke Sp is smaller than the predetermined value Spa, the process proceeds to step S6. When it is judged that the sensed pedal stroke Sp is equal to or greater than the predetermined value Spa, the process proceeds to step S8.

At step S6, it is judged whether or not the sensed master cylinder hydraulic pressure Pm is equal to or greater than the predetermined value Pma. It is judged that the sensed master cylinder hydraulic pressure Pm is smaller than the predetermined value Pma, the process proceeds to step S7. When it is judged that the sensed master cylinder hydraulic pressure Pm is equal to or greater than the predetermined value Pma, the process proceeds to step S8.

At step S7, the gate in valve 23 is actuated (opened). Then, the process proceeds to step S9.

At step S8, the gate in valve 23 is not actuated (closed). Then, the process proceeds to step S9.

At step S6, when the master cylinder hydraulic pressure Pm is equal to or greater than the predetermined value Pma, the process proceeds to step S8. The gate in valve 23 is closed. When the master cylinder hydraulic pressure Pm is smaller than the predetermined value Pma, the process proceeds to step S7. The gate in valve 23 is opened. With this, it is possible to prevent the master cylinder hydraulic pressure Pm of the high pressure (which is equal to or greater than the predetermined value Pma) from acting through the second suction passage 13 to the passage on the suction side of the pump 30, and to protect this passage.

At step S9, the target wheel cylinder hydraulic pressure Pw0 is calculated based on the sensed master cylinder hydraulic pressure Pm or (the driver's desired braking force represented by) the pedal stroke Sp. In particular, the target value Pw0 of the wheel cylinder hydraulic pressure to satisfy the characteristics shown in FIG. 2 or FIG. 3 is calculated. Then, the process proceeds to step S10.

At step S10, it is judged whether or not the pressure increase control of the wheel cylinder hydraulic pressure Pw is performed. For example, when the sensed wheel cylinder hydraulic pressure Pw is smaller than the target wheel cylinder hydraulic pressure Pw0, it is judged that the pressure increase control is performed. When it is judged that the pressure increase control is performed, the process proceeds to step S12. When it is judged that the pressure increase control is not performed, the process proceeds to step S11.

At step S11, it is judged whether or not the holding control of the wheel cylinder hydraulic pressure Pw is performed. For example, when the sensed wheel cylinder hydraulic pressure Pw is greater than the target wheel cylinder hydraulic pressure Pw0, it is judged that the holding control is not performed, and that the pressure decrease control is performed. When it is judged that the holding control is performed, the process proceeds to step S13. When it is judged that the holding control is not performed (the pressure decrease control is performed), the process proceeds to step S14.

At step S12, the pump 30 (the motor 3) is actuated in the state where the brake operation is performed. Moreover, the gate out valve 20 is actuated and controlled in the valve closing direction (to the intermediate opening degree by the balance control). The pressure increase valve 21 is not actuated (or controlled in the valve opening direction). The pressure decease valve 22 is not actuated (or controlled in the valve closing direction). By controlling the gate out valve 20 in the valve closing direction, the flow of the brake fluid in the supply passage 11 through the gate out valve 20 is restricted. The pump 30 sucks the brake fluid within the master cylinder 4 through the suction passage (the first suction passage 15 or the second suction passage 13) which is selected at steps S4 to S8. The pump 30 increases the brake hydraulic pressure (the master cylinder hydraulic pressure Pm) generated in the master cylinder 4, and increases the wheel cylinder hydraulic pressure Pw. That is, the wheel cylinder hydraulic pressure Pw is increased to be greater than the master cylinder hydraulic pressure Pm. Then, the process proceeds to step S15.

At step S13, the pump 30 (the motor 3) is not actuated in a state where the brake operation is performed. The gate out valve 20 is actuated (closed). The pressure increase valve 21 is not actuated (opened). The pressure decrease valve 22 is not actuated (closed). With this, the brake fluid within the wheel cylinder 5 is confined in the passage between the pressure decease valve 22, the check valve 28, the gate out valve 20, and the check valve 26.

With this, the wheel cylinder hydraulic pressure Pw is held. Then, the process proceeds to step S15.

At step S14, the pump 30 (the motor 3) is not actuated in the state where the brake operation is performed. The gate out valve 20 is actuated and controlled in the valve closing direction (to the intermediate opening degree by the balance control). The pressure increase valve 21 is not actuated (or controlled in the valve opening direction). The pressure decrease valve 22 is not actuated (or controlled in the valve closing direction). The wheel cylinder 5 is connected with the master cylinder 4 through the pressure increase passage 11a and so on (the pressure increase valve 21) and the supply passage 11 (the gate out valve 20), so as to return the brake fluid within the wheel cylinder 5 to the master cylinder 4. With this, the wheel cylinder hydraulic pressure Pw is decreased. Then, the process proceeds to step S15.

At step S15, it is judged whether or not the sensed wheel cylinder hydraulic pressure Pw is substantially identical to (substantially corresponds to) the target wheel cylinder hydraulic pressure Pw0. When it is judged that the sensed wheel cylinder hydraulic pressure Pw is substantially identical to the target wheel cylinder hydraulic pressure Pw0, the process proceeds to step S16. When it is judged that the sensed wheel cylinder hydraulic pressure Pw is not substantially identical to the target wheel cylinder hydraulic pressure Pw0, the process returns to step S10.

At step S16, it is judged whether or not the brake hydraulic pressure control (the boost control) is finished. When it is judged that the control is finished, the process proceeds to step S17. When it is not judged that the control is finished, the process returns to step S9.

At step S17, similarly to step S1, the actuators of the hydraulic pressure unit 6 are brought to the non-actuation state. Then, this control cycle is finished.

### Operations of First Embodiment

Next, operations (functions) of the device 1 are illustrated.

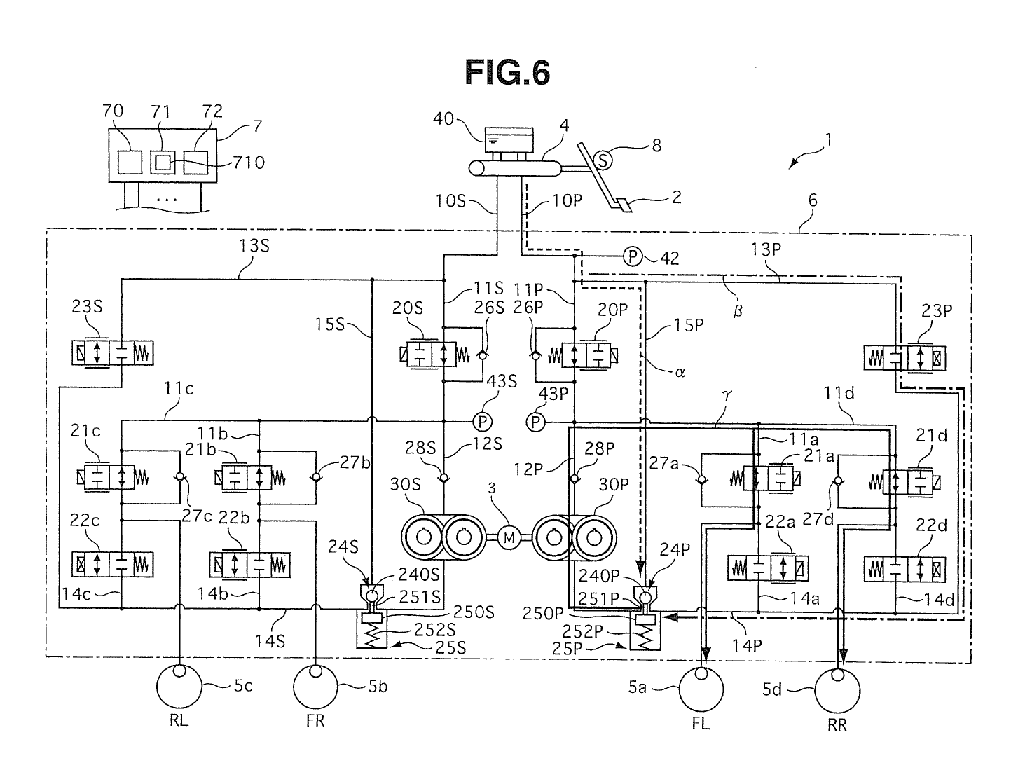

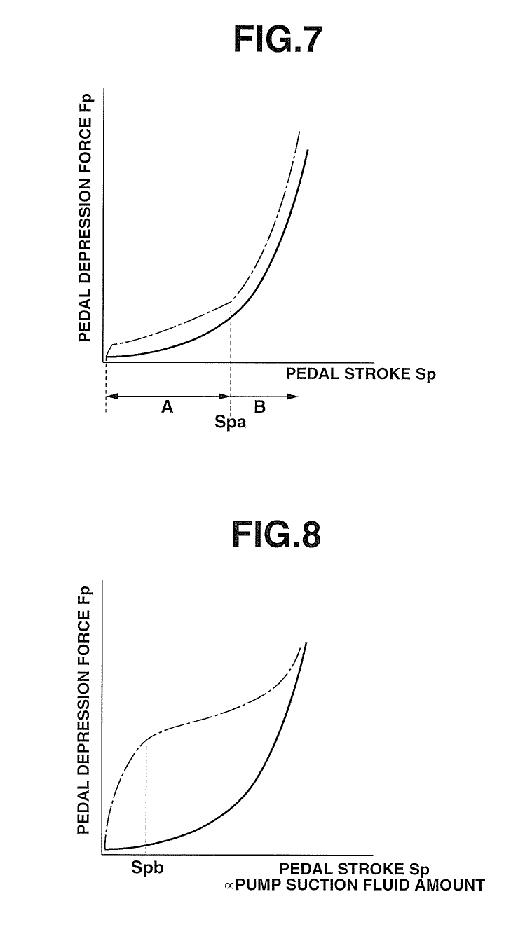

FIG. 6 shows a brake circuit of the device 1 according to this embodiment, similarly to FIG. 1. In a state where the depression operation of the brake pedal 2 is performed, the brake hydraulic pressure control (for example, the boost control) is performed. A flow of the brake fluid at the pressure increase control of the wheel cylinder hydraulic pressure Pw is represented by an arrow. For simplification of the illustration, a flow of the brake fluid of the only P system is shown. However, it is identical in the S system. FIG. 7 is a relational characteristics between the pedal stroke Sp and the pedal depression force Fp at the pressure increase control of the wheel cylinder in a state where the depression operation of the brake pedal 2 is performed. When the pressure increase control of the wheel cylinder hydraulic pressure Pw is performed in the state where the brake pedal 2 is depressed, at step S12, the pump 30 is driven. Moreover, the gate out valve 20 is controlled to the intermediate opening degree by the balance control. The pressure increase valve 21 is not actuated (or is controlled in the valve opening direction). The pressure decrease valve 22 is not actuated (or is controlled in the valve closing direction). The pump 30 sucks the brake fluid within the master cylinder 4 based on the increase of the sensed pedal stroke Sp, and increases the wheel cylinder hydraulic pressure Pw.

When the brake pedal 2 is slowly depressed, or when the brake pedal 2 is depressed at the normal speed, the suction passage selecting section 710 selects the first suction passage 15, as the suction passage for flowing the brake fluid into the internal reservoir 25. In particular, the gate in valve 23 is closed. Accordingly, the pump 30 sucks the brake fluid within the master cylinder 4 through the first suction passage 15, as shown by a dashed line arrow a of FIG. 6. In particular, the pressure of the internal reservoir 25 is decreased by the actuation of the pump 30. With this, the check valve 24 is opened, so that the first suction passage 15 is brought to the connection state. Accordingly, the brake fluid flowing into the internal reservoir 25 through the first suction passage 15 is sucked by the pump 30. On the other hand, the second suction passage 13 is brought to the non-actuation state by the valve close of the gate in valve 23. The brake fluid does not flow into the internal reservoir 25 through the second suction passage 13. The pump 30 discharges the sucked brake fluid to the supply passage 11 on the wheel cylinder 5's side of the gate out valve 20, as shown by a solid line arrow r of FIG. 6. This brake fluid is regulated by the gate out valve 20, and supplied toward the wheel cylinder 5. With this, the wheel cylinder hydraulic pressure Pw is increased. A most part of the brake fluid flowing through the first suction passage 15 into the internal reservoir 25 is sucked by the pump 30 without storing within the internal reservoir 25. Accordingly, the brake fluid amount discharged from the master cylinder 4 (that is, the pedal stroke Sp) corresponds to the suction fluid amount of the pump 30 (which is substantially proportional relationship). The pedal stroke Sp mainly relates to the suction fluid amount of the pump 30. The pedal stroke Sp is restricted by this. That is, it is considered that the fluid amount which is sucked by the pump 30, and which is transmitted to the wheel cylinder 5 is identical to the fluid amount transmitted from the master cylinder. The brake pedal 2 can be stroked (moved) by this fluid amount. Moreover, when the brake pedal 2 is slowly depressed, or when the brake pedal 2 is depressed at the normal speed, the response delay of the pump 30 (the motor 3), that is, the delay of the increase of the suction fluid amount (the pedal stroke Sp) of the pump 30 is relatively small. Accordingly, the above-described relational characteristics at this time becomes the solid line of FIG. 7. That is, the above-described relational characteristics becomes the characteristics (the exponent function characteristics) in which the pedal depression force Fp is increased in accordance with the increase of the pedal stroke Sp, and in which the increase rate thereof is gently increased in accordance with the increase of the pedal stroke Sp. In a range A in which the pedal stroke Sp is smaller than the predetermined value Spa, the increase amount of the pedal stroke Sp with respect to the pedal depression force Fp is relatively large. Accordingly, the brake pedal 2 has a soft (light) pedal operation feeling. In a range B in which the pedal stroke Sp becomes equal to or greater than the predetermined value Spa, the increase amount of the pedal stroke Sp with respect to the pedal depression force Fp becomes relatively small. Accordingly, the brake pedal 2 has the pedal operation feeling harder as the stroke proceeds.

In the sudden depression state where the brake pedal 2 is suddenly depressed, the suction passage selecting section 710 basically selects the second suction passage 13 as the suction passage for flowing the brake fluid into the internal reservoir 25. In particular, the gate in valve 23 is opened. Accordingly, the pump 30 sucks the brake fluid within the master cylinder 4 through the second suction passage 13 as shown by an arrow β of a chain line of FIG. 6. In particular, in the sudden depression state, the pressure decrease within the internal reservoir 25 by the operation of the motor 30, and accordingly the valve opening of the check valve 24 is delayed due to the response delay of the pump 30 (the motor 3). The check valve 24 is brought to the valve closing state by the actuation of the master cylinder hydraulic pressure Pm. With this, the first suction passage 15 becomes the disconnection state. The brake fluid does not flow through the first suction passage 15 into the internal reservoir 25. On the other hand, the second suction passage 13 becomes the connection state by the valve opening of the gate in valve 23. The brake fluid from the master cylinder 4 flows through the second suction passage 13 into the internal reservoir 25. In this case, (an upper limit of) the stroke amount of the piston 250 of the internal reservoir 25 is set greater than (an upper limit of) the stroke amount of the check valve 24. Accordingly, even after the stroke of the check valve 24 (the valve element 240) is limited by the valve closing of the check valve 24, it is possible to stroke the piston 250 of the internal reservoir 25. Consequently, it is possible to further surely flow the brake fluid through the gate in valve 23 (the second suction passage 13) to the internal reservoir 25. Moreover, the gate out valve 20 is controlled in the valve closing direction in the sudden depression state. With this, it is possible to further surely flow the brake fluid through the gate in valve 23 (the second suction passage 13) into the internal reservoir 25. The pump 30 sucks the brake fluid flowing into the internal reservoir 25 (through the second suction passage 13), as shown by a solid arrow y of FIG. 6. The pump 30 discharges the sucked brake fluid to a portion of the supply passage 11 on the wheel cylinder 5's side of the gate out valve 20, and supply the sucked brake fluid toward the wheel cylinder 5. With this, the wheel cylinder hydraulic pressure Pw is increased.

Accordingly, the above-described relational characteristics in the sudden depression state becomes a state shown by a chain line of FIG. 7. That is, the relational characteristics in the sudden depression state becomes a relational characteristics identical to the relational characteristics (the solid line of FIG. 7) when the brake pedal 2 is slowly depressed, or when the brake pedal 2 is depressed at the normal speed. Accordingly, the pedal feeling becomes the pedal feeling identical to that when the brake pedal 2 is slowly depressed, or when the brake pedal 2 is depressed at the normal speed. Hereinafter, the above-described relational characteristics in the sudden depression state is illustrated by using a comparative example. This comparative example is different from the present embodiment in a point that the second suction passage 13 (the gate in valve 23) is not provided. The comparative example has a configuration in which the pump 30 sucks the brake fluid through the first suction passage 15 even in the sudden depression state. FIG. 8 shows the above-described relational characteristics. The relational characteristics of the comparative example when the brake pedal 2 is slowly depressed, or when the brake pedal 2 is depressed at the normal speed is identical to the relational characteristics this embodiment, as shown by a solid line of FIG. 8. On the other hand, the relational characteristics of the comparative example in the sudden depression state is different from the relational characteristics of this embodiment, and becomes a state shown by a chain line of FIG. 8. That is, in the comparative example, the pump 30 sucks the brake fluid within the master cylinder 4 through the first suction passage 15, irrespective of the brake operation state. The pedal stroke Sp corresponds to the suction fluid amount of the pump 30 (substantially proportional relationship), so that the pedal stroke Sp is restricted by the suction fluid amount of the pump 30. Accordingly, in the sudden depression state, the response delay of the pump 30 (the motor 3) is generated. When the suction speed of the pump 30 becomes relatively slow, the suction fluid amount of the pump 30 is hardly increased. Consequently, even when the pedal depression force Fp is increased by the depression of the brake pedal 2 by the driver, the brake pedal 2 is not immediately stroked. On the other hand, when the response of the pump 30 (the motor 3) follows up, the pump suction fluid amount is increased at last. The brake pedal 2 is stroked. Accordingly, the characteristics becomes the characteristics shown by the chain line of FIG. 8. In a region where the pedal stroke Sp is smaller than a predetermined value Spb, that is, at the initial stage of the brake operation, the increase amount of the pedal stroke Sp with respect to the pedal depression force Fp is relatively small. The brake pedal 2 becomes the hard (weight) pedal operation feeling. That is, at the sudden depression, the brake pedal 2 becomes a characteristic in which the brake pedal 2 is hardly stroked even when the driver depresses the brake pedal 2. The feeling that the pedal does not enter is generated. Consequently, the pedal operation feeling may be deteriorated.

Contrary to this, the device 1 according to this embodiment flows the brake fluid within the master cylinder 4 through the second suction passage 13 into the internal reservoir 25 even when the response delay of the pump 30 (the motor 3) is generated in the sudden depression state, as described above. It is possible to store the brake fluid flowing through the second suction passage 13 into the internal reservoir 25, within the internal reservoir 25. Accordingly, the brake fluid amount transmitted from the master cylinder 4 (that is, the pedal stroke Sp) is increased independently of the more or less of the suction fluid amount of the pump 30. That is, the pedal stroke Sp does not directly relate to the suction fluid amount of the pump 30 (which is not substantially proportional relationship). The pedal stroke Sp can be increased irrespective of the response delay of the pump 30 (the motor 3). With this, it is possible to ensure the pedal stroke Sp even in the sudden depression state. As shown by the chain line of FIG. 7, it is possible to attain the relational characteristics identical to the relational characteristics when the brake pedal 2 is slowly depressed, or when the brake pedal 2 is depressed at the normal speed. Accordingly, it is possible to suppress the deterioration of the pedal operation feeling.

In particular, when the sudden depression of the brake pedal 2 is sensed, in a range A where the pedal stroke Sp is smaller than the predetermined value Spa, and when the brake operation amount is smaller than the predetermined amount (at the sudden depression in narrow sense (in a narrow sense)), the gate in valve 23 is actuated (opened) to ensure the pedal stroke Sp. Accordingly, at the sudden depression (in narrow sense), the characteristics becomes characteristics by which the increase amount of the pedal stroke Sp with respect to the pedal depression force Fp is relatively large. With this, it is possible to attain the relational characteristics identical to the relational characteristics when the brake pedal 2 is slowly depressed, or when the brake pedal 2 is depressed at the normal speed. With this, it is possible to suppress the deterioration of the feeling of the pedal operation. On the other hand, even in the sudden depression state (in a broad sense), when the pedal stroke Sp becomes equal to or greater than the predetermined value Spa, and the brake operation amount becomes equal to or greater than the predetermined amount (after the sudden depression (in the narrow sense (in the narrow sense)), the increase amount of the pedal stroke Sp with respect to the pedal depression force Fp may be small. Rather, it is preferable that the feeling of the brake pedal 2 is harder as the stroke proceeds. Accordingly, in this stroke region B, the gate in valve 23 is not actuated (closed) to suppress the excessive increase of the pedal stroke Sp with respect to the pedal depression force Fp. That is, the first suction passage 15 is selected so that the pump 30 sucks the brake fluid transmitted from the master cylinder 4 through the check valve 24. With this, after the sudden depression (in the narrow sense), it is possible to attain the relational characteristics identical to the relational characteristics when the brake pedal 2 is slowly depressed, or when the brake pedal 2 is depressed at the normal speed. Consequently, it is possible to obtain the more appropriate pedal feeling.

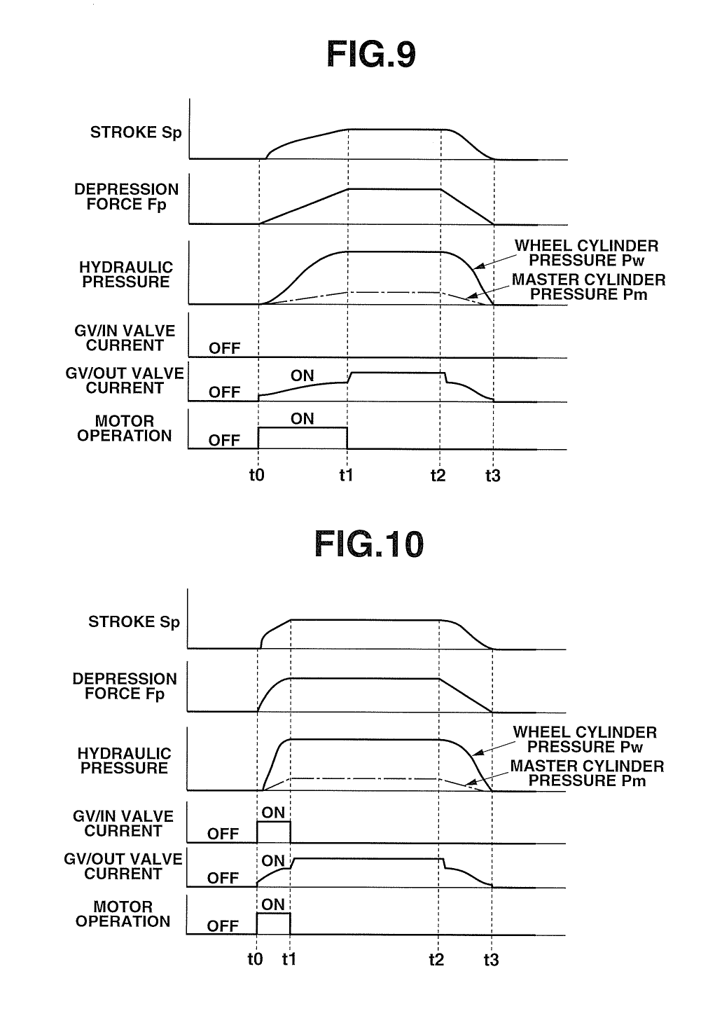

FIG. 9 to FIG. 11 are time charts showing one example of time variations of the various variables when the brake pedal 2 is depressed and the device 1 performs the brake hydraulic pressure control (for example, the boost control).

FIG. 9 is a time chart when the brake pedal 2 is slowly depressed, or when the brake pedal 2 is depressed at the normal speed.

At time t0, the brake pedal 2 is depressed. In the flowcharts of FIGS. 4 and 5, the process proceeds along the steps S1 to S4→S8 to S10→S12→S15. The command (current) that the gate in valve 23 is not actuated (is closed), that the gate out valve 20 is actuated (is brought to the intermediate opening degree), and that the motor 3 is actuated is outputted. The pedal depression force Fp is increased. The master cylinder hydraulic pressure Pm is increased in accordance with the increase of the pedal depression force Fp. The motor 3 is actuated from time t0. The pump 3 sucks the brake fluid from the internal reservoir 25 at the predetermined suction speed. The suction of the pump 30 (the pressure decease within the internal reservoir 25) is not delayed with respect to the increase of the master cylinder hydraulic pressure Pm since the brake operation speed is slow or the normal speed. Accordingly, the check valve 24 is opened, so that the brake fluid flows from the master cylinder 4 through the first suction passage 15 into the internal reservoir 25. The pump 30 sucks this brake fluid, and discharges this brake fluid to the wheel cylinder 5's side. Consequently, the pedal stroke Sp is started to be increased in accordance with the increase of the pedal depression force Fp to follow the relational characteristics (the solid line) of FIG. 7. Moreover, the wheel cylinder hydraulic pressure Pw is started to be increased. The wheel cylinder hydraulic pressure Pw is controlled to the target value greater than the master cylinder hydraulic pressure Pm by the balance control of the gate out valve 20.

At time t1, the depression of the brake pedal 2 (the pedal depression force Fp, that is, the master cylinder hydraulic pressure Pm) is held. In the flowcharts of FIGS. 4 and 5, the process proceeds along the steps S1 to S4→S8 to S10→S11→S13→S15. The command that the gate in valve 23 is not actuated, that the gate out valve 20 is actuated (closed), and that the motor 3 is not actuated is outputted. The gate in valve 23 and the gate out valve 20 are closed. The check valve 24 is also closed by the non-actuation of the pump 30. Consequently, the pedal stroke Sp is held. Moreover, the pump 30 is not actuated, and the gate out valve 20 is closed, so that the wheel cylinder hydraulic pressure Pw is held to the constant value.

At time t2, the depression of the brake pedal 2 is returned, and the pedal depression force Fp, that is, the master cylinder hydraulic pressure Pm is started to be decreased. In the flowcharts of FIGS. 4 and 5, the process proceeds along steps S1 to S4→S8 to S10→S11→S14→S15. The command that the gate in valve 23 is not actuated, that the gate out valve 20 is actuated (is brought to the intermediate opening degree), and that the motor 3 is not actuated is outputted. The brake fluid within the wheel cylinder 5 is returned through the supply passage (the gate out valve 20) to the master cylinder 4 (the reservoir tank 40). Accordingly, the pedal stroke Sp becomes smaller in accordance with the decrease of the pedal depression force Fp. Moreover, the wheel cylinder hydraulic pressure Pw is decreased.

FIG. 10 is a time chart when the brake pedal 2 is suddenly depressed. The pedal stroke Sp is smaller than the predetermined value Spa. The master cylinder hydraulic pressure Pm is smaller than the predetermined value Pma.

At time t0, the brake pedal 2 is depressed. The sudden depression state is judged until time t1.

In the flowcharts of FIGS. 4 and 5, the process proceeds along steps S1 to S7→S9→S10→S12→S15. The command that the gate in valve 23 is actuated (opened), that the gate out valve 20 is actuated (is brought to the intermediate opening degree), and that the motor 3 is actuated is outputted. The pedal depression force Fp is increased. The master cylinder hydraulic pressure Pm is increased in accordance with the increase of the pedal depression force Fp. The motor 3 is actuated from time t0. The pump 30 sucks the brake fluid from the internal reservoir 25 at the predetermined suction speed. The brake operation speed is the sudden speed. Accordingly, the suction of the pump 30 (the pressure decrease within the internal reservoir 25) is delayed with respect to the increase of the master cylinder hydraulic pressure Pm. Consequently, the check valve 24 is closed. The brake fluid flows from the master cylinder 4 into the internal reservoir 25 through the second suction passage 13, without passing through the first suction passage 15. Moreover, the pump 30 sucks this brake fluid, and discharges this brake fluid to the wheel cylinder 5's side. Therefore, the pedal stroke Sp is started to be increased in accordance with the increase of the pedal depression force Fp to follow the relational characteristics (the chain line) of FIG. 7. Moreover, the wheel cylinder hydraulic pressure Pw is started to be increased. The wheel cylinder hydraulic pressure Pw is controlled to the target value greater than the master cylinder hydraulic pressure Pm by the balance control of the gate out valve 20. In this way, the pedal stroke Sp according to the pedal depression force Fp at the sudden depression from time t0 to time t1 is ensured. With this, it is possible to suppress the deterioration of the pedal operation feeling.

At time t1, the depression of the brake pedal 2 is held. In the flowcharts of FIGS. 4 and 5, the process proceeds along steps S1 to S4→S8 to S10→S11→S13→S15. The gate in valve 23 is not actuated. The operations after time t1 is identical to those of FIG. 9.

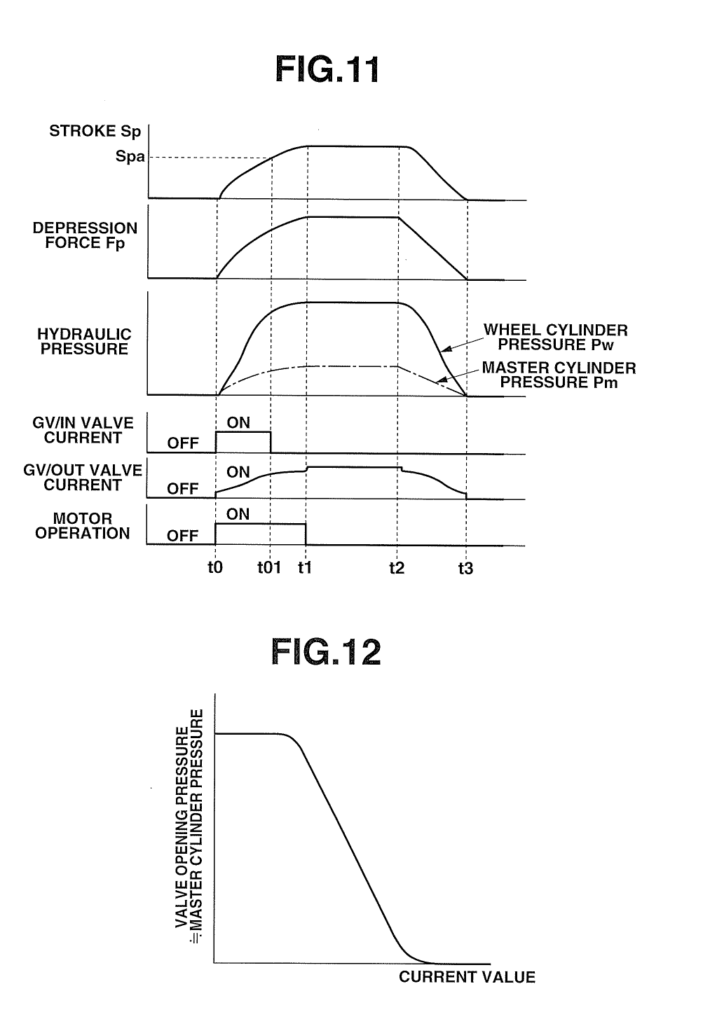

FIG. 11 is a time chart when the brake pedal 2 is suddenly depressed. The pedal stroke Sp becomes equal to or greater than the predetermined value Spa. The master cylinder hydraulic pressure Pm is smaller than the predetermined value Pma.

At time t0, the brake pedal 2 is depressed. The sudden depression state is judged until time t1. From time t0 to time t01, the pedal stroke Sp is smaller than the predetermined value Spa. In the flowcharts of FIGS. 4 and 5, the process proceeds along the flow of steps S1 to S7→S9→S10→S12→S15. Similarly to the time periods t0 to t1 of FIG. 10, the pedal stroke Sp according to the pedal depression force Fp at the sudden depression is ensured.

At time t01, the pedal stroke Sp becomes equal to or greater than the predetermined value Spa In the flowcharts of FIGS. 4 and 5, the process proceeds along the flow of steps S1 to S5→S8 to S10→S12→S15. The gate in valve 23 is not actuated (is closed). After the actuation of the motor 3 is started (brought to the ON state) at time t0, the response delay of the motor 3 is dissolved at time t01. Accordingly, even when the brake operation speed is the sudden speed, the suction of the pump 30 (the pressure decrease within the internal reservoir 25) is not delayed with respect to the increase of the master cylinder hydraulic pressure Pm. Consequently, the check valve 24 is opened. The brake fluid flows from the master cylinder 4 into the internal reservoir 25 through the first suction passage 15, not through the second suction passage 13. Moreover, the pump 30 sucks this brake fluid, and discharges this brake fluid to the wheel cylinder 5's side. Accordingly, the pedal stroke Sp is increased in accordance with the increase of the pedal depression force Fp to follow the relational characteristics (the chain line) of FIG. 7. That is, during the time periods t01 to t1, even in the sudden depression state, the pump 30 sucks the brake fluid through the first suction passage 15. With this, it is possible to attain the appropriate characteristics (the hard characteristics) of the pedal stroke Sp with respect to the pedal depression force Fp, and to attain the more appropriate pedal depression feeling.

After the time t1 at which the depression of the brake pedal is started to be held, the operations are identical to those of FIG. 9.

Hereinafter, the other operations of the device 1 are illustrated.

The master cylinder 4 generates the master cylinder hydraulic pressure Pm corresponding to the pedal depression force Fp. The pump 30 increases the generated master cylinder hydraulic pressure Pm so as to increase the wheel cylinder hydraulic pressure Pw. In this way, even in the configuration in which there is no boost device that is disposed between the brake pedal 2 and the master cylinder 4, that is arranged to boost (amplify) the force transmitted from the brake pedal 2, to transmit this force to the master cylinder 4, and to generate the master cylinder hydraulic pressure Pm by this boosted brake operation force, it is possible to attain the boosting function by using the hydraulic pressure unit 6. That is, the brake system can be a booster-less configuration in which a mechanical booster device (booster) is not provided between the brake pedal 2 and the master cylinder 4. Besides, the above-described type booster device (for example, the negative pressure booster which uses the negative pressure generated by the engine, an electric booster and so on) may be provided. This embodiment employs the booster-less configuration. The variation of the master cylinder hydraulic pressure Pm is easier to be transmitted to the brake pedal 2. Accordingly, it is possible to more effectively obtain the above-described effect to improve the pedal operation feeling by selecting the suction passage according to the brake operation state.

The brake fluid flowing from the master cylinder 4 into the internal reservoir 25 by the valve opening of the gate in valve 23 in the sudden braking state is sucked by the pump 30, and supplied to the wheel cylinder 5. That is, the brake fluid supplied from the master cylinder 4 to the internal reservoir 25 for ensuring the pedal stroke Sp is used for increasing the pressure of the wheel cylinder 5. Accordingly, the balance (inflow and outflow) of the fluid amount of the brake circuit is automatically ensured. Consequently, it is possible to simplify the configuration of the control and so on. Besides, it is optional to employ a configuration which is arranged so as not to suck the brake fluid flowing through the second suction passage 13 into the reservoir 25 in the sudden braking state, by the pump 30.

The internal reservoir 25 into which the brake fluid flows in the sudden braking state for ensuring the pedal stroke Sp is also a reservoir into which the brake fluid whose the pressure is decreased by the antilock brake control section 72. Accordingly, by combinedly using the internal reservoir 25 of the original hydraulic pressure unit 6 which is arranged to perform the antilock brake control, as the internal reservoir 25 for ensuring the pedal stroke Sp in the sudden braking state, it is possible to readily apply the existing (original) system (the hydraulic pressure unit and the control logic), and to decease the cost.

### Effects of First Embodiment

Hereinafter, effects of the brake control device 1 according to the first embodiment are described.

(A1) There are provided the brake operation amount sensing section 70 arranged to sense the operation amount (the pedal stroke Sp) of the brake operation member (the brake pedal 2) by the driver;

the pump 30 arranged to suck the brake fluid within the master cylinder 4 based on the increase of the operation amount (the pedal stroke Sp) of the brake operation member which is sensed by the brake operation amount sensing section 70, and to increase the wheel cylinder hydraulic pressure Pw;

the first suction passage 15 connecting the master cylinder 4 and the suction side of the pump 30;

the reservoir (the internal reservoir 25) provided on the first suction passage 15;

the second suction passage 13 provided in parallel with the first suction passage 15, and arranged to connect the master cylinder 4 and the reservoir (the internal reservoir 25);

the gate in valve 23 provided on the second suction passage 13;

the gate in valve 23 is opened to flow the brake fluid into the reservoir (the internal reservoir 25) when the brake operation amount sensing section 70 senses the predetermined sudden braking state.

Accordingly, it is possible to improve the operation feeling at the sudden braking, and to suppress the unnatural feeling of the driver.

(A2) The master cylinder 4 generates the brake hydraulic pressure (the master cylinder hydraulic pressure Pm) corresponding to the operation force (the pedal depression force Fp) by the brake operation member (the brake pedal 2). The pump 30 increases the generated brake hydraulic pressure (the master cylinder hydraulic pressure Pm), and increases the wheel cylinder hydraulic pressure Pw.

Accordingly, it is possible to obtain the booster-less device.

(A3) The pump 30 sucks the brake fluid flowing into the reservoir (the internal reservoir 25).

Accordingly, it is possible to ensure the balance of the fluid amount, and to simplify the configuration.

(A4) There is provided the antilock brake control section 72 configured to decrease the wheel cylinder hydraulic pressure Pw. The brake fluid whose the pressure is decreased by the antilock brake control section 72 flows into the reservoir (the internal reservoir 25).

Accordingly, it is possible to apply the original system into the practical use, and to decrease the cost.

(A5) When the brake operation amount sensing section 70 senses the brake operation amount which is equal to or greater than the predetermined amount (the predetermined amount Spa), the gate in valve 23 is closed.

Accordingly, it is possible to suppress the excessive increase of the brake operation amount (the pedal stroke Sp), and to improve the operation feeling.

(A6) The reservoir (the internal reservoir 25) includes a piston 250 arranged to be stroked based on the inflow of the brake fluid, and a pressure regulating valve (check valve 24) arranged to regulate the brake fluid amount flowing from the first suction passage 15 into the reservoir (the internal reservoir 25) in cooperation with the piston 250. The pump 30 sucks the brake fluid through the regulating valve (the check valve 24) after the gate in valve 23 is closed.

Accordingly, it is possible to mechanically suppress the deterioration of the operation feeling after the sudden depression (in the narrow sense), without the special control.

### Second Embodiment

A brake control device 1 according to the second embodiment is arranged to attain the target relational characteristics (hereinafter, Fp-Sp characteristics) between the pedal depression force Fp and the pedal stroke Sp by controlling the gate in valve 23 while selecting the second suction passage 13.

The gate in valve 23 according to this embodiment is a proportional valve arranged to vary the opening degree or the valve opening pressure by the current value, like the gate out valve 20, except for the difference of the normally-opening or the normally-closing. The gate in valve 23 can be controlled by the balancing control. FIG. 12 is a map showing the relational characteristics between the valve opening pressure of the gate in valve 23 and the current value. The valve opening pressure of the gate in valve 23 is a pressure difference between the pressure on the upstream side of the gate in valve 23 (the pressure corresponding to the master cylinder hydraulic pressure Pm), and the pressure on the downstream side of the gate in valve 23 (the pressure corresponding to the internal reservoir 25). When the pressure within the internal reservoir 25 is considered as substantially zero, the valve opening pressure is substantially equal to the master cylinder hydraulic pressure Pm. Accordingly, by regulating the current value of the gate in valve 23 based on this map, it is possible to control the valve opening pressure, that is, the master cylinder hydraulic pressure Pm, to a desired value.

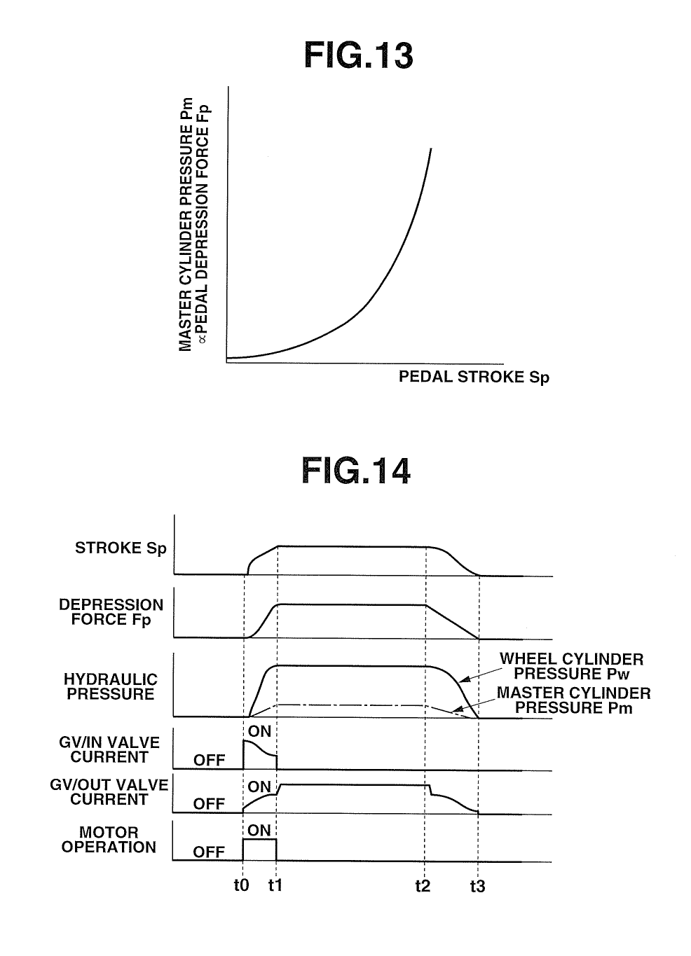

FIG. 13 is a map showing the relational characteristics between the pedal stroke Sp and the target value of the master cylinder hydraulic pressure Pm in the sudden depression state. The relationship of this map between the pedal stroke Sp and the master cylinder hydraulic pressure Pm is set equal to the relationship between the pedal stroke Sp and the pedal depression force Fp when the brake pedal 2 is slowly depressed, or when the brake pedal 2 is depressed at the normal speed. That is, the pedal depression force Fp is substantially proportional to the master cylinder hydraulic pressure Pm. The relational characteristics of FIG. 13 has a shape identical to the relational characteristics of the solid line of FIG. 7.

The flowchart representing the control operation by the control unit 7 according to this embodiment is identical to those of FIG. 4 and FIG. 5, except for the below-described points relating to the control of the gate in valve 23.

That is, at step S7, the target value Pm0 of the master cylinder hydraulic pressure Pm is set based on the map of FIG. 13 in accordance with the sensed pedal stroke Sp. Then, the current value when the gate in valve 23 is actuated is determined based on the map of FIG. 12 in accordance with the set master cylinder hydraulic pressure target value Pm0.

In this way, in this embodiment, it is focused on that the pedal depression force Fp can be regulated by controlling the master cylinder hydraulic pressure Pm. The current value of the gate in valve 23 is controlled based on the sensed pedal stroke Sp so that the master cylinder hydraulic pressure Pm becomes the target value Pm0 shown in FIG. 12. That is, the valve opening pressure (or the opening degree) of the gate in valve 23 is set by adjusting the current value so that the pedal depression force Fp becomes appropriate value. Accordingly, it is possible to set the Fp-Sp characteristics in the sudden depression state, to the target characteristics. With this, it is possible to obtain more preferable pedal feeling.

FIG. 14 is a time chart identical to that of FIG. 10, by the device 1 according to this embodiment.

When the brake pedal 2 is depressed at time t0, in the flowcharts of FIGS. 4 and 5, the process proceeds along the flow of steps 51 to S7→S9→S10→S12→S15. The command that the gate in valve 23 is actuated (is brought to the intermediate opening degree), that the gate out valve 20 is actuated (is brought to the intermediate opening degree), and that the motor 3 is actuated is outputted. After time t0, when the brake fluid flows from the master cylinder 4 through the second suction passage 13 into the internal reservoir 25 by the valve opening, the current value of the gate in valve 23 is determined as described above. The master cylinder hydraulic pressure Pm is controlled in accordance with the pedal stroke Sp to follow the characteristics of the map of FIG. 13. Accordingly, during the time period until time t1 at which the gate in valve 23 is closed, it is possible to obtain the more preferable Fp-Sp characteristics, and to improve the pedal feeling at the sudden depression.

The other points are identical to those of FIG. 10.

In this embodiment, the gate in valve 23 is not ON/OFF valve. The gate in valve 23 is the proportional control valve. Accordingly, it is possible to be easy to generate the preferable pedal feeling as described above. Besides, the ON/OFF valve may be used as the gate in valve 23, not the proportional control valve. In this case, it is possible to attain the intermediate opening degree by controlling the effective current, for example, by the PWM control. However, it is preferable that the proportional control valve is used like this embodiment, for improving the feeling of the driver while suppressing the noise and the vibration.

### Third Embodiment

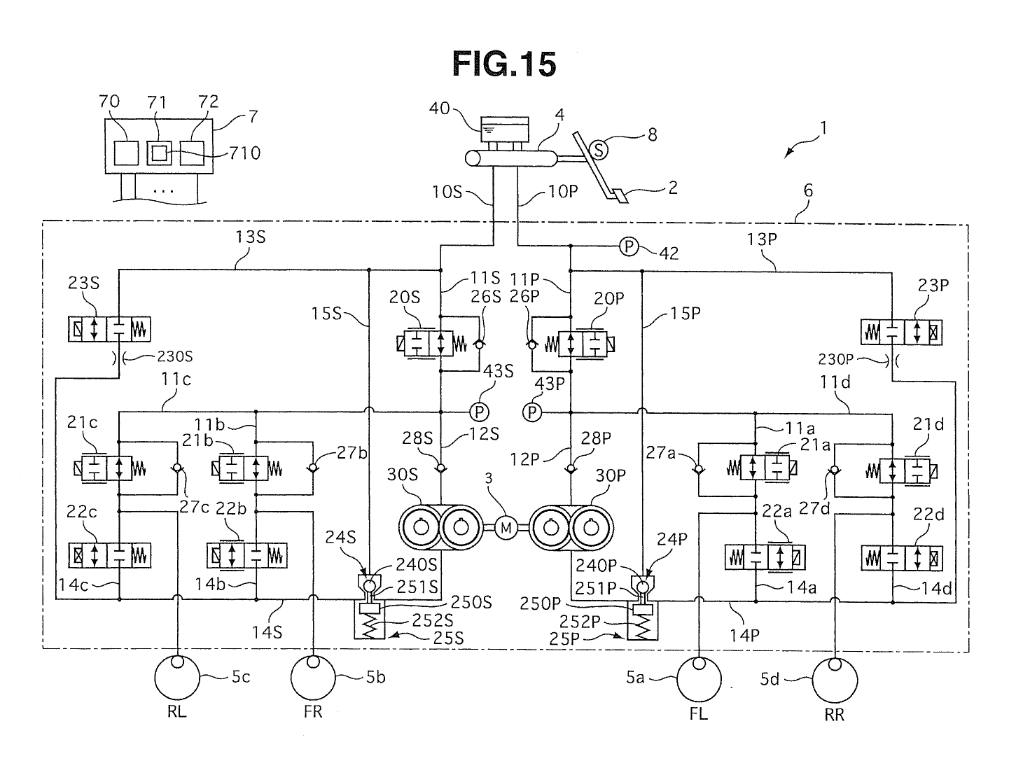

In the second embodiment, the gate in valve 23 is the proportional valve arranged to vary the opening degree and so on by the current value. The opening degree and so on of the gate in valve 23 is set by adjusting the current value so that the pedal depression force Fp becomes the appropriate value. In this embodiment, the gate in valve 23 is the ON/OFF valve, as shown in FIG. 15. Moreover, unlike the second embodiment, an orifice 230 serving as a throttling portion is provided on the downstream side of the gate in valve 23 (the internal reservoir 25's side) in the second suction passage 13. That is, the gate in valve 23 is constituted by a combination of the ON/OFF valve and the orifice. By previously adjusting the diameter (the throttling amount) of the orifice 230, the opening degree of the gate in valve 23 is substantially set. With this, similarly to the second embodiment, the pedal depression force Fp is set to the appropriate value with respect to the pedal stroke Sp.

In this case, by performing the ON/OFF control of the gate in valve 23, it is possible to generate the preferable pedal feeling by the low cost, relative to the second embodiment. Besides, the orifice may be provided on the upstream side of the gate in valve 23 (the master cylinder 4's side) in the second suction passage 13.

### Other Embodiments

Hereinbefore, the embodiments to attain the present invention are illustrated based on the embodiments.

However, the concrete configurations of the present invention are not limited to the embodiments. The present invention includes the modifications (variations) of the design as long as it is not deviated from the gist of the invention.

For example, the present invention is not limited to the boost control. The suction passage selecting means according to the present invention may be applied to the other brake hydraulic pressure control (for example, the regenerative cooperative brake control) as long as the pump sucks the brake fluid from the master cylinder at the brake operation of the driver, and discharges the brake fluid to the wheel cylinder's side to increase the wheel cylinder hydraulic pressure.

Moreover, the problem of the deterioration of the brake operation feeling is not limited to a configuration that the first suction passage 15 becomes the mechanically disconnection state due to the response delay of the pump 30 (the motor 3) in the predetermined sudden depression state. The problem of the deterioration of the brake operation feeling may be generated in a configuration in which the suction of the pump 30 from the master cylinder 4 through the first suction passage 15 is prevented due to the response delay of the pump 30 (the motor 3). Accordingly, the suction passage selecting means according to the present invention may be applied to a configuration in which a normal internal reservoir (not the internal reservoir 25 which is integrated with the check valve 24 like the embodiments, and which includes the pressure regulating function (the stroke of the reservoir piston 250 and the opening and the closing of the check valve 24 are cooperated with each other) is provided on the first suction passage 15. In this case, it is conceivable that the gate valve is provided on the first suction passage 15 on the upstream side (the master cylinder side) of the internal reservoir, and that the gate valve is arranged to switch the connection state of the first suction passage 15 without cooperating with the internal reservoir. On the other hand, in this embodiment, there is provided the internal reservoir 25 having the pressure regulating function. Relative to the configuration in which the gate valve is provided, it is unnecessary that the another control is provided. It is possible to mechanically regulate the brake operation feeling. For example, there is a benefit in which the operation feeling deterioration after the sudden depression (in the narrow sense) can be suppressed without the need of the special control.

Moreover, the problems of the deterioration of the brake operation feeling may be generated in the configuration in which the suction of the brake fluid by the pump 30 from the master cylinder 4 through the first suction passage 15 in the predetermined sudden braking state is prevented due to the causes other than the response delay of the pump 30 (the motor 3). Accordingly, the suction passage selecting means of the present invention is limited to be applied to the configuration in which the valve is provided on the first suction passage 15 on the upstream side of the internal reservoir (the master cylinder's side). For example, the suction passage selecting means of the present invention may be applied to a configuration in which the throttling portion such as the orifice to restrict the flow rate on the first suction passage 15 is provided. In this case, by selecting the second suction passage 13 in the predetermined sudden braking state, it is possible to ensure the pedal stroke Sp, and to improve the brake operation feeling.

As the gate out valve 20, the ON/OFF valve (not the proportional control valve) may be used. In this case, it is possible to attain the intermediate opening degree by controlling the effective current, for example, by the PWM control. However, for improving the feeling of the driver while suppressing the noise and the vibration, it is preferable to use the proportional control valve like the embodiments.

Hereinafter, the present invention grasped from the embodiments and effects thereof are described.

(A7) In the brake control device described in (A1),

a first brake circuit which is bifurcated from the first suction passage, and which connects the discharge side of the pump, the master cylinder, and the wheel cylinder;

the gate out valve provided in the first brake circuit; when the brake operation amount sensing section senses the sudden braking state, the gate out valve is controlled in the valve closing direction.

It is possible to further surely flow the brake fluid through the gate in valve into the reservoir.

(A8) In the brake control device described in (A7),

the reservoir includes a piston arranged to be stroked (moved) by the inflow of the brake fluid, and a pressure regulating valve arranged to be stroked in cooperation with the piston, and arranged to prevent the inflow of the brake fluid from the first suction passage into the reservoir by the stroke of the predetermined amount,

the stroke amount of the piston is greater than the stroke amount of the pressure regulating valve, and the piston can be stroked through the second suction passage.

It is possible to surely flow the brake fluid through the gate in valve into the reservoir.

(A9) In the brake control device described in (A1),

the gate in valve is a proportional control valve.

It is easy to generate the pedal feeling.

(A10) In the brake control device described in (A1),

the gate in valve is an ON/OFF valve. The brake control device further includes an orifice provided on the downstream side of the gate in valve.

It is possible to generate the pedal feeling at the low cost.

(B1) The brake control device including the brake operation amount sensing section configured to sense the operation amount of the brake operation member by the driver;

the pump arranged to suck the brake fluid within the master cylinder based on the increase of the operation amount of the brake operation member which is sensed by the brake operation amount sensing section, and to increase the wheel cylinder hydraulic pressure;

the first suction passage connecting the master cylinder and the suction side of the pump;

the reservoir which is provided on the first suction passage, and into which the brake fluid from the master cylinder flows;

the second suction passage which is provided parallel to the first suction passage, and which connects the master cylinder and the reservoir; and

the selecting means arranged to select the suction passage from the first suction passage and the second suction passage in accordance with the brake operation state sensed by the brake operation amount sensing section,

the brake fluid flowing through the selected suction passage into the reservoir.

(B2) In the brake control device described in (B1),

the gate in valve is provided on the second suction passage;

the gate in valve is opened when the brake operation amount sensing section senses the predetermined sudden braking state.

(B3) In the brake control device described in (B2),

the master cylinder generates the brake hydraulic pressure corresponding to the operation force by the brake operation member;

the pump increases the generated brake hydraulic pressure to increase the wheel cylinder hydraulic pressure. (B4) In the brake control device described in (B3),

the pump sucks the brake fluid flowing into the reservoir.

(B5) In the brake control device described in (B1),

when the brake operation amount sensing section senses the brake operation amount which is equal to or greater than the predetermined amount, the gate in valve is closed.

(B6) In the brake control device described in (B5),

the reservoir includes the piston arranged to be stroked (moved) based on the inflow of the brake fluid, and the pressure regulating valve arranged to regulate the brake hydraulic amount flowing from the first suction passage into the reservoir in cooperation with the piston;

the pump sucks the brake fluid through the pressure regulating valve after the gate in valve is closed.

(B7) In the brake control device described in (B1),
the brake control device further includes the first brake circuit which is bifurcated from the first suction passage, and which connects the discharge side of the pump, the master cylinder, and the wheel cylinder;

the gate out valve provided in the first brake circuit;

when the brake operation amount sensing section senses the predetermined sudden braking state, the gate out valve is controlled in the valve closing direction. (B8) In the brake control device described in (B1),
the gate in valve is a proportional control valve.

(C1) A brake control device includes:

a brake operation amount sensing section arranged to sense the operation amount of the brake operation member by the driver;

the pump arranged to suck the brake fluid within the master cylinder based on the increase of the operation amount of the brake operation member which is sensed by the brake operation amount sensing section, and to increase the pressure of the wheel cylinder hydraulic pressure;

the first suction passage connecting the master cylinder and the suction side of the pump;

the second suction passage which is provided independently of the first suction passage, and which connects the master cylinder and the second suction passage;

the reservoir provided on the first suction passage and the second suction passage;

the pressure regulating valve which is provided on the first suction passage between the master cylinder and the reservoir, and which is arranged to be closed when the brake fluid of the predetermined amount flows into the reservoir;

the gate in valve provided on the second suction passage;

when the brake operation amount sensing section senses the predetermined sudden braking state, the pressure regulating valve is closed, and the gate-in valve is opened so that the brake fluid flows through the second suction passage into the reservoir.

(C2) In the brake control device described in (C1),

the master cylinder generates the brake hydraulic pressure corresponding to the operation force of the brake operation member; and the pump increases the generated brake hydraulic pressure to increase the wheel cylinder hydraulic pressure.

### EXPLANATION OF SYMBOLS

2 brake pedal (brake operation member)
4 master cylinder
13 second suction passage
15 first suction passage
23 gate-in valve
24 check valve (pressure regulating valve)
25 internal reservoir (reservoir)
250 piston
30 pump
70 brake operation amount sensing section
72 anti-lock brake control section.

1. A brake control device comprising:
a brake operation amount sensing section configured to sense an operation amount of a brake operation member by a driver;
a pump arranged to suck a brake fluid within a master cylinder based on an increase of the operation amount of the brake operation member which is sensed by the brake operation amount sensing section, and to increase a wheel cylinder hydraulic pressure;
a first suction passage connecting the master cylinder and a suction side of the pump;
a reservoir provided on the first suction passage;
a second suction passage which is provided in parallel with the first suction passage, and which connects the master cylinder and the reservoir;
a gate in valve provided on the second suction passage;
the gate in valve being opened to flow the brake fluid to the reservoir when the brake operation amount sensing section senses a predetermined sudden braking state.

2. The brake control device as claimed in claim 1, wherein the master cylinder generates the brake hydraulic pressure corresponding to an operation force by the brake operation member; and the pump increases the generated brake hydraulic pressure to increase the wheel cylinder hydraulic pressure.

3. The brake control device as claimed in claim 2, wherein the pump sucks the brake fluid flowing into the reservoir.

4. The brake control device as claimed in claim 3, wherein the brake control device further comprises an antilock brake control section arranged to decrease the wheel cylinder hydraulic pressure; and the brake fluid whose the pressure is decreased by the antilock brake control section flows into the reservoir.

5. The brake control device as claimed in claim 1, wherein the gate in valve is closed when the brake operation amount sensing section senses the brake operation amount which is equal to or greater than a predetermined amount.

6. The brake control device as claimed in claim 5, wherein the reservoir includes a piston which is arranged to be stroked by an inflow of the brake fluid, and a pressure regulating valve arranged to regulate a brake fluid amount flowing from the first suction passage to the reservoir in cooperation with the piston; and the pump sucks the brake fluid through the pressure regulating valve after the gate in valve is closed.

7. The brake control device as claimed in claim 1, wherein the brake control device further comprises a first brake circuit which is bifurcated from the first suction passage, and which connects a discharge side of the pump, the master cylinder, and the wheel cylinder, and a gate out valve provided in the first brake circuit; and the gate out valve is controlled in a valve closing direction when the brake operation amount sensing section senses a predetermined sudden braking state.

8. The brake control device as claimed in claim 7, wherein the reservoir includes a piston arranged to be stroked by an inflow of the brake fluid, and a pressure regulating valve arranged to be stroked in cooperation with the piston, and to prevent the inflow of the brake fluid from the first suction passage into the reservoir when being stroked by the predetermined amount; the stroke amount of the piston is greater than a stroke amount of the pressure regulating valve; and the piston can be stroked through the second suction passage.

9. The brake control device as claimed in claim 1, wherein the gate in valve is a proportional control valve.

10. The brake control device as claimed in claim 1, wherein the gate in valve is an ON/OFF valve; and the brake control device includes an orifice provided on a downstream side of the gate-in valve.

11. A brake control device comprising:
a brake operation amount sensing section configured to sense an operation amount of a brake operation member by a driver;
a pump configured to suck a brake fluid within a master cylinder based on an increase of the operation amount of the brake operation member which is sensed by the brake operation amount sensing section, and to increase the wheel cylinder hydraulic pressure;
a first suction passage connecting the master cylinder and a suction side of the pump;
a reservoir which is provided on the first suction passage, and into which the brake fluid from the master cylinder flows;
a second suction passage which is provided in parallel with the first suction passage, and which connects the master cylinder and the reservoir; and
a selecting means section which is configured to select the suction passage from the first suction passage and the second suction passage in accordance with the brake operation state sensed by the brake operation amount sensing section, the brake fluid flowing through the selected suction passage into the reservoir.

12. The brake control device as claimed in claim 11, wherein the second suction passage is provided with the gate in valve; and the gate in valve is opened when the brake operation amount sensing section senses a predetermined sudden braking state.

13. The brake control device as claimed in claim 12, wherein the master cylinder generates the brake hydraulic pressure corresponding to the operation force of the brake operation member; and the pump increases the generates brake hydraulic pressure to increase the wheel cylinder hydraulic pressure.

14. The brake control device as claimed in claim 13, wherein the pump sucks the brake fluid flowing into the reservoir.

15. The brake control device as claimed in claim 1, wherein the gate in valve is closed when the brake operation amount sensing section senses the brake operation amount which is equal to or greater than the predetermined amount.

16. The brake control device as claimed in claim 15, wherein the reservoir includes a piston arranged to be stroked based on the inflow of the brake fluid, and a pressure regulating valve arranged to regulate the brake fluid amount from the first suction passage to the reservoir in cooperation with the piston; and the pump is arranged to suck the brake fluid through the pressure regulating valve after the gate in valve is closed.

17. The brake control device as claimed in claim 11, wherein the brake control device further includes a first brake circuit which is bifurcated from the first suction passage, and which connects a discharge side of the pump, the master cylinder, and the wheel cylinder, and a gate out valve provided in the first brake circuit; the gate out valve is controlled in the valve closing direction when the brake operation amount sensing section senses a predetermined sudden braking state.

18. The brake control device as claimed in claim 11, wherein the gate in valve is a proportional control valve.

19. A brake control device comprising:
a brake operation amount sensing section arranged to sense an operation amount of a brake operation member by a driver;
a pump arranged to suck a brake fluid within a master cylinder based on an increase of the operation amount of the brake operation member which is sensed by the brake operation amount sensing section, and to increase the wheel cylinder hydraulic pressure;
a first suction passage connecting the master cylinder and a suction side of the pump;
a second suction passage which is provided independently of the first suction passage, and which is connected to the master cylinder;
a reservoir which is provided on the first suction passage and the second suction passage;
a pressure regulating valve provided on the first suction passage between the master cylinder and the reservoir, and arranged to be closed when the brake fluid of a predetermined amount flows into the reservoir; and
a gate in valve provided on the second suction passage, when the brake operation amount sensing section senses a predetermined sudden braking state, the pressure regulating valve is closed, the gate in valve is opened so that the brake fluid flows through the second suction passage into the reservoir.

20. The brake control device as claimed in claim 19, wherein the master cylinder generates the brake hydraulic pressure corresponding to the operation force by the brake operation member; and the pump is arranged to increase the generated brake hydraulic pressure, and to increase the wheel cylinder hydraulic pressure.
